(19) United States
(12) Patent Application Publication
(10) Pub. No.: US 2024/0224242 A1
(43) Pub. Date: Jul. 4, 2024

(54) METHOD AND DEVICE IN NODES USED FOR WIRELESS COMMUNICATION

(71) Applicants: Jin LIU, SHANGHAI (CN); Xiaobo ZHANG, SHANGHAI (CN)

(72) Inventors: Jin LIU, SHANGHAI (CN); Xiaobo ZHANG, SHANGHAI (CN)

(73) Assignee: SHANGHAI LANGBO COMMUNICATION TECHNOLOGY COMPANY LIMITED, Shanghai, OT (CN)

(21) Appl. No.: 18/212,186

(22) Filed: Jun. 21, 2023

(30) Foreign Application Priority Data
Jun. 27, 2022 (CN) 202210735692.9

(51) Int. Cl. H04W 72/0446; H04W 72/0453; H04W 72/20

(52) U.S. Cl. CPC H04W 72/0446; H04W 72/0453; H04W 72/20

(57) ABSTRACT

Disclosure provides a method and device in a node for wireless communications. A first node receives a first signal on a first time-frequency resource block; transmits first information on a target time-frequency resource block, the first information is used to indicate whether the first signal is correctly received; a first resource pool comprises a first time-frequency resource group, and the first time-frequency resource block is a first-type time-frequency resource block in the first time-frequency resource group; time-domain resources occupied by the first time-frequency resource group in time domain are not greater than a first equivalent period; a second period is a time interval between any two adjacent candidate resource sets in time domain among multiple candidate resource sets comprised in a second resource pool. The present application solves the mapping problem of data channels and feedback channels of different resource pools.

### CROSS REFERENCE TO RELATED APPLICATIONS

This application claims the priority benefit of Chinese Patent Application 202210735692.9, filed on Jun. 27, 2022, the full disclosure of which is incorporated herein by reference.

### BACKGROUND

### Technical Field

The present application relates to transmission methods and devices in wireless communication systems, and in particular to a sidelink-related transmission scheme and device in wireless communications.

### Related Art

Starting from Long Term Evolution (LTE), 3rd Generation Partner Project (3GPP) has been developing sidelink (SL) as a direct communication method between users, and has completed a first New Radio (NR) SL standard of “5G V2X with NR Sidelink” in Release-16 (Rel-16). In Rel-16, the NR SL is mainly designed for Vehicle-To-Everything (V2X), but it can also used for Public Safety. With the further enhancement of the NR SL, Rel-17 has introduced power saving schemes such as periodic-based partial sensing (PBPS), continuous partial sensing (CPS), random selection, and discontinuous reception (DRX), as well as various inter UE coordination schemes to provide more reliable channel resources.

In order to meet commercial application scenarios, the industry has put forward new demands for V2X, comprising higher data throughput and support for new carrier frequency. Therefore, at 3GPP RAN-#94e meeting, a Work Item Description (WID) RP-213678 for the evolution of NR SL was approved, which officially starts the standardization work of NR V2X Rel-18.

### SUMMARY

According to a work plan in RP-213678, NR Rel-18 needs to support SL Carrier aggregation (CA) technology, and carrier components adopted by each User Equipment (UE) may be different. While in the existing NR Rel-16/17 system, data transmitted by a user on a PSSCH needs to receive a corresponding HARQ feedback in a same SL resource pool (RP) where the PSSCH is located. When two users adopt different carrier components (CCs) to transmit SL data, it may lead to peer users not having corresponding carrier components to execute a HARQ feedback, resulting in a decrease in the reliability of SL transmission.

In response to the above issues, the present application discloses a resource mapping method to effectively feed back data of multiple resource pools. It should be noted that the embodiments in a User Equipment (UE) in the present application and characteristics of the embodiments may be applied to a base station if no conflict is incurred, and vice versa. And the embodiments in the present application and the characteristics in the embodiments can be arbitrarily combined if there is no conflict. Though originally targeted at SL, the present application is also applicable to uplink (UL). Though originally targeted at single-carrier communications, the present application is also applicable to multicarrier communications. Though originally targeted at single-antenna communications, the present application is also applicable to multi-antenna communications. Besides, the present application is not only targeted at scenarios of V2X scenarios, but also at communication scenarios between terminals and base stations, terminals and relays as well as relays and base stations, where similar technical effect can be achieved. Additionally, the adoption of a unified solution for various scenarios, including but not limited to V2X scenarios and communication scenarios between terminals and base stations, contributes to the reduction of hardware complexity and costs.

It should be noted that interpretations of the terminology in the present application refer to definitions given in the 3GPP TS36 series, TS37 series, TS38 series, as well as definitions given in Institute of Electrical and Electronics Engineers (IEEE) protocol specifications.

The present application provides a method in a first node for wireless communications, comprising:
receiving a first signal on a first time-frequency resource block; and
as a response to receiving the first signal, transmitting first information on a target time-frequency resource block, the first information being used to indicate whether the first signal is correctly received;
herein, a first resource pool comprises a first time-frequency resource group, the first time-frequency resource group comprises at least one first-type time-frequency resource block, and the first time-frequency resource block is a first-type time-frequency resource block in the first time-frequency resource group; the first resource pool comprises multiple first-type slots in time domain, and time-domain resources occupied by any first-type time-frequency resource block in the first time-frequency resource group in time domain belong to a first-type slot in the first resource pool; time-domain resources occupied by the first time-frequency resource group in time domain are not greater than a first equivalent period, and the first equivalent period comprises at least one first-type slot; a second resource pool comprises multiple candidate resource sets, a second period is a time interval between any two adjacent candidate resource sets in time domain among the multiple candidate resource sets, a target resource set is one of the multiple candidate resource sets, the target resource set comprises multiple third-type time-frequency resource blocks, and the target time-frequency resource block is a third-type time-frequency resource block in the target resource set; the first time-frequency resource block is associated with the target time-frequency resource block; the second resource pool comprises multiple second-type slots in time domain, and time-domain resources occupied by any third-type time-frequency resource block in the target resource set in time domain belong to a second-type slot in the second resource pool; the second period comprises at least one second-type slot, and the first equivalent period is related to the second period.

In one embodiment, a problem to be solved in the present application is: when two users adopt different CCs to transmit SL data, it may lead to the peer users not having corresponding CCs to execute a HARQ feedback, resulting in a decrease in the reliability of SL transmission.

In one embodiment, a problem to be solved in the present application is: when two users adopt different resource pools to transmit SL data, it may lead to the peer users not having corresponding transmission resource pools to execute a HARQ feedback, resulting in a decrease in the reliability of SL transmission.

In one embodiment, a method in the present application is: establishing a relation between a data channel in a first resource pool and a feedback channel in a second resource pool.

In one embodiment, a method in the present application is: constructing a mapping relation between a data channel in a first resource pool, a data channel in a second resource pool and a feedback channel in a second resource pool.

In one embodiment, a method in the present application is: establishing a relation between data channels and feedback channels of different Subcarrier Spacings (SCSs).

In one embodiment, the advantage of the above method is that feedback signals of data channels for different resource pools are multiplexed in a same resource pool, thereby avoiding the problem of reduced transmission reliability incurred by the lack of an effective feedback resource pool.

According to one aspect of the present application, the above method is characterized in that the first equivalent period is related to both a length of a first-type slot in the first resource pool and a length of a second-type slot in the second resource pool.

According to one aspect of the present application, the above method is characteristic in that the first resource pool comprises multiple first-type time-frequency resource blocks, any first-type time-frequency resource block in the first resource pool comprises multiple first-type subcarriers in frequency domain, the second resource pool comprises multiple second-type time-frequency resource blocks, and any second-type time-frequency resource block in the second resource pool comprises multiple second-type subcarriers in frequency domain; the first equivalent period is related to both an SCS of any first-type subcarrier in the first resource pool and an SCS of any second-type subcarrier in the second resource pool.

According to one aspect of the present application, the above method is characterized in that the first resource pool comprises multiple first-type sub-channels infrequency domain; the first time-frequency resource block occupies at least one of the multiple first-type sub-channels in frequency domain; a number of the multiple first-type sub-channels comprised in the first resource pool in frequency domain and the first equivalent period are used to determine a number of all first-type time-frequency resource block(s) in the first time-frequency resource group.

According to one aspect of the present application, the above method is characterized in that the target resource set comprises multiple candidate resource groups, and any of the multiple candidate resource groups comprises at least one third-type time-frequency resource block in the target resource set; a target resource group is one of the multiple candidate resource groups, and the target time-frequency resource block belongs to the target resource group; the first time-frequency resource block is used to determine the target resource group.

According to one aspect of the present application, the above method is characterized in that the second resource pool comprises a second time-frequency resource group, and the second time-frequency resource group comprises multiple second-type time-frequency resource blocks; any second-type time-frequency resource block in the second time-frequency resource group occupies a second-type slot in the second resource pool in time domain; the target resource set comprises a first target resource subset and a second target resource subset, the first target resource subset is associated with the first time-frequency resource group, and the second target resource subset is associated with the second time-frequency resource group; the second target resource subset is used to determine a starting position of the first target resource subset in frequency domain.

According to one aspect of the present application, the above method is characterized in that a first frequency-domain offset is used to determine frequency-domain resources occupied by the target resource set in the second resource pool.

According to one aspect of the present application, the above method is characterized in that all the multiple third-type time-frequency resource blocks comprised in the target resource set belong to a target slot in time domain, and the target slot is a second-type slot in the second resource pool; a time interval between a first-type slot occupied by the first time-frequency resource block in the first resource pool and the target slot is not less than a minimum time interval.

According to one aspect of the present application, the above method is characterized in that the first node is a UE.

According to one aspect of the present application, the above method is characterized in that the first node is a relay node.

According to one aspect of the present application, the above method is characterized in that the first node is a base station.

The present application provides a method in a second node for wireless communications, comprising:
transmitting a first signal on a first time-frequency resource block;
receiving first information on a target time-frequency resource block, the first information being used to indicate whether the first signal is correctly received;
herein, a first resource pool comprises a first time-frequency resource group, the first time-frequency resource group comprises at least one first-type time-frequency resource block, and the first time-frequency resource block is a first-type time-frequency resource block in the first time-frequency resource group; the first resource pool comprises multiple first-type slots in time domain, and time-domain resources occupied by any first-type time-frequency resource block in the first time-frequency resource group in time domain belong to a first-type slot in the first resource pool; time-domain resources occupied by the first time-frequency resource group in time domain are not greater than a first equivalent period, and the first equivalent period comprises at least one first-type slot; a second resource pool comprises multiple candidate resource sets, a second period is a time interval between any two adjacent candidate resource sets in time domain among the multiple candidate resource sets, a target resource set is one of the multiple candidate resource sets, the target resource set comprises multiple third-type time-frequency resource blocks, and the target time-frequency resource block is a third-type time-frequency resource block in the target resource set; the first time-frequency resource block is associated with the target time-frequency resource block; the second resource pool comprises multiple second-type slots in time domain, and time-domain resources occupied by any third-type time-frequency resource block in the target resource set in time domain belong to a second-type slot in the second resource pool; the second period comprises at least one second-type slot, and the first equivalent period is related to the second period.

According to one aspect of the present application, the above method is characterized in that the first equivalent period is related to both a length of a first-type slot in the first resource pool and a length of a second-type slot in the second resource pool.

According to one aspect of the present application, the above method is characteristic in that the first resource pool comprises multiple first-type time-frequency resource blocks, any first-type time-frequency resource block in the first resource pool comprises multiple first-type subcarriers in frequency domain, the second resource pool comprises multiple second-type time-frequency resource blocks, and any second-type time-frequency resource block in the second resource pool comprises multiple second-type subcarriers in frequency domain; the first equivalent period is related to both an SCS of any first-type subcarrier in the first resource pool and an SCS of any second-type subcarrier in the second resource pool.

According to one aspect of the present application, the above method is characterized in that the first resource pool comprises multiple first-type sub-channels infrequency domain; the first time-frequency resource block occupies at least one of the multiple first-type sub-channels in frequency domain; a number of the multiple first-type sub-channels comprised in the first resource pool in frequency domain and the first equivalent period are used to determine a number of all first-type time-frequency resource block(s) in the first time-frequency resource group.

According to one aspect of the present application, the above method is characterized in that the target resource set comprises multiple candidate resource groups, and any of the multiple candidate resource groups comprises at least one third-type time-frequency resource block in the target resource set; a target resource group is one of the multiple candidate resource groups, and the target time-frequency resource block belongs to the target resource group; the first time-frequency resource block is used to determine the target resource group.

According to one aspect of the present application, the above method is characterized in that the second resource pool comprises a second time-frequency resource group, and the second time-frequency resource group comprises multiple second-type time-frequency resource blocks; any second-type time-frequency resource block in the second time-frequency resource group occupies a second-type slot in the second resource pool in time domain; the target resource set comprises a first target resource subset and a second target resource subset, the first target resource subset is associated with the first time-frequency resource group, and the second target resource subset is associated with the second time-frequency resource group; the second target resource subset is used to determine a starting position of the first target resource subset in frequency domain.

According to one aspect of the present application, the above method is characterized in that a first frequency-domain offset is used to determine frequency-domain resources occupied by the target resource set in the second resource pool.

According to one aspect of the present application, the above method is characterized in that all the multiple third-type time-frequency resource blocks comprised in the target resource set belong to a target slot in time domain, and the target slot is a second-type slot in the second resource pool; a time interval between a first-type slot occupied by the first time-frequency resource block in the first resource pool and the target slot is not less than a minimum time interval.

According to one aspect of the present application, the above method is characterized in that the second node is a UE.

According to one aspect of the present application, the above method is characterized in that the second node is a relay node.

According to one aspect of the present application, the above method is characterized in that the second node is a base station.

The present application provides a first node for wireless communications, comprising:
a first receiver, receiving a first signal on a first time-frequency resource block; and
a first transmitter, as a response to receiving the first signal, transmitting first information on a target time-frequency resource block, the first information being used to indicate whether the first signal is correctly received;
herein, a first resource pool comprises a first time-frequency resource group, the first time-frequency resource group comprises at least one first-type time-frequency resource block, and the first time-frequency resource block is a first-type time-frequency resource block in the first time-frequency resource group; the first resource pool comprises multiple first-type slots in time domain, and time-domain resources occupied by any first-type time-frequency resource block in the first time-frequency resource group in time domain belong to a first-type slot in the first resource pool; time-domain resources occupied by the first time-frequency resource group in time domain are not greater than a first equivalent period, and the first equivalent period comprises at least one first-type slot; a second resource pool comprises multiple candidate resource sets, a second period is a time interval between any two adjacent candidate resource sets in time domain among the multiple candidate resource sets, a target resource set is one of the multiple candidate resource sets, the target resource set comprises multiple third-type time-frequency resource blocks, and the target time-frequency resource block is a third-type time-frequency resource block in the target resource set; the first time-frequency resource block is associated with the target time-frequency resource block; the second resource pool comprises multiple second-type slots in time domain, and time-domain resources occupied by any third-type time-frequency resource block in the target resource set in time domain belong to a second-type slot in the second resource pool; the second period comprises at least one second-type slot, and the first equivalent period is related to the second period.

The present application provides a second node for wireless communications, comprising:
a second transmitter, transmitting a first signal on a first time-frequency resource block; and
a second receiver, receiving first information on a target time-frequency resource block, the first information being used to indicate whether the first signal is correctly received;
herein, a first resource pool comprises a first time-frequency resource group, the first time-frequency resource group comprises at least one first-type time-frequency resource block, and the first time-frequency resource block is a first-type time-frequency resource block in the first time-frequency resource group; the first resource pool comprises multiple first-type slots in time domain, and time-domain resources occupied by any first-type time-frequency resource block in the first time-frequency resource group in time domain belong to a first-type slot in the first resource pool; time-domain resources occupied by the first time-frequency resource group in time domain are not greater than a first equivalent period, and the first equivalent period comprises at least one first-type slot; a second resource pool comprises multiple candidate resource sets, a second period is a time interval between any two adjacent candidate resource sets in time domain among the multiple candidate resource sets, a target resource set is one of the multiple candidate resource sets, the target resource set comprises multiple third-type time-frequency resource blocks, and the target time-frequency resource block is a third-type time-frequency resource block in the target resource set; the first time-frequency resource block is associated with the target time-frequency resource block; the second resource pool comprises multiple second-type slots in time domain, and time-domain resources occupied by any third-type time-frequency resource block in the target resource set in time domain belong to a second-type slot in the second resource pool; the second period comprises at least one second-type slot, and the first equivalent period is related to the second period.

In one embodiment, the present application is advantageous in the following aspects:
a problem to be solved in the present application is: when two users use different CCs to transmit SL data, it may lead to the peer users not having corresponding carrier components to perform HARQ feedback, resulting in a decrease in the reliability of SL transmission.
a problem to be solved in the present application is: when two users use different resource pools to transmit SL data, it may lead to the peer users not having corresponding transmission resource pools to perform HARQ feedback, resulting in a decrease in the reliability of SL transmission.
the present application establishes a relation between a data channel in a first resource pool and a feedback channel in a second resource pool.
the present application constructs a mapping relation between a data channel in a first resource pool, a data channel in a second resource pool, and a feedback channel in a second resource pool.
the present application establishes a relation between data channels and feedback channels of different SCSs.
the present application multiplexes feedback signals of data channels for different resource pools in a same resource pool, thereby avoiding the problem of reduced transmission reliability incurred by the lack of an effective feedback resource pool.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of the processing of a first node according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of radio signal transmission according to one embodiment of the present application;

FIG. 6 illustrates a schematic diagram of relations among a first resource pool, a second resource pool, a first-type slot, a second-type slot, a first time-frequency resource group, a first equivalent period and a second period according to one embodiment of the present application;

FIG. 7 illustrates a schematic diagram of relations among a first time-frequency resource block, a target resource set and a target time-frequency resource block according to one embodiment of the present application;

FIG. 8 illustrates a structure block diagram of a processor in a first node according to one embodiment of the present application;

FIG. 9 illustrates a structure block diagram of a processor in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

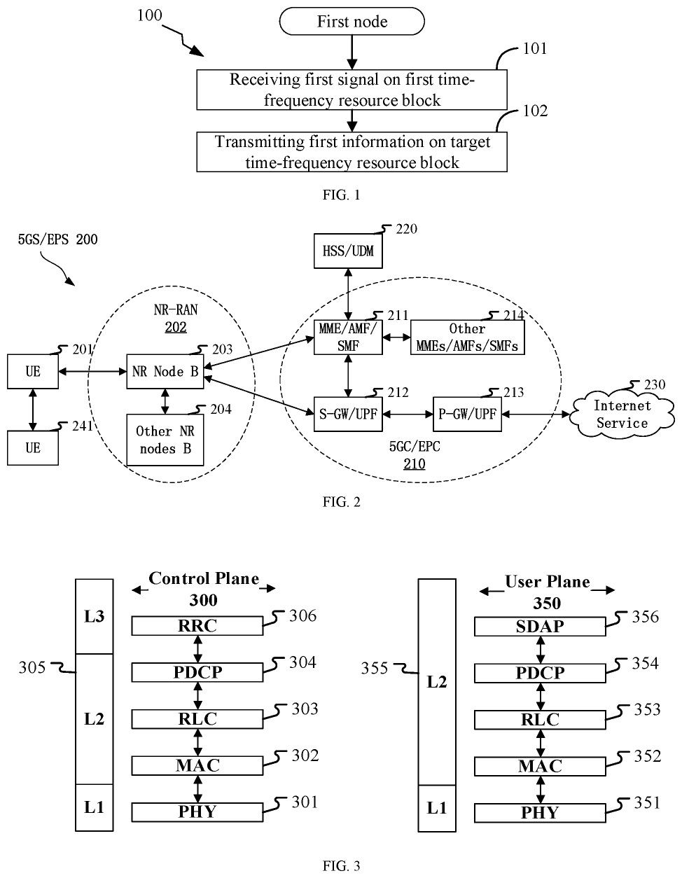

Embodiment 1 illustrates a flowchart of the processing of a first node according to one embodiment of the present application, as shown in FIG. 1. In FIG. 1, each block represents a step.

In Embodiment 1, a first node in the present application first receives a first signal on a first time-frequency resource block in step 101; then in step 102, as a response to receiving the first signal, transmits first information on a target time-frequency resource block, the first information is used to indicate whether the first signal is correctly received; a first resource pool comprises a first time-frequency resource group, the first time-frequency resource group comprises at least one first-type time-frequency resource block, and the first time-frequency resource block is a first-type time-frequency resource block in the first time-frequency resource group; the first resource pool comprises multiple first-type slots in time domain, and time-domain resources occupied by any first-type time-frequency resource block in the first time-frequency resource group in time domain belong to a first-type slot in the first resource pool; time-domain resources occupied by the first time-frequency resource group in time domain are not greater than a first equivalent period, and the first equivalent period comprises at least one first-type slot; a second resource pool comprises multiple candidate resource sets, a second period is a time interval between any two adjacent candidate resource sets in time domain among the multiple candidate resource sets, a target resource set is one of the multiple candidate resource sets, the target resource set comprises multiple third-type time-frequency resource blocks, and the target time-frequency resource block is a third-type time-frequency resource block in the target resource set; the first time-frequency resource block is associated with the target time-frequency resource block; the second resource pool comprises multiple second-type slots in time domain, and time-domain resources occupied by any third-type time-frequency resource block in the target resource set in time domain belong to a second-type slot in the second resource pool; the second period comprises at least one second-type slot, and the first equivalent period is related to the second period.

In one embodiment, the first resource pool comprises at least one resource pool.

In one embodiment, the first resource pool comprises at least one sidelink resource pool.

In one embodiment, the first resource pool comprises all or partial resources of a sidelink resource pool.

In one embodiment, the first resource pool is provided by a higher-layer signaling.

In one embodiment, the first resource pool is provided by a Radio Resource Control (Radio Resource Control) layer signaling.

In one embodiment, the first resource pool comprises multiple first-type slots in time domain.

In one embodiment, the first resource pool comprises multiple first-type symbols in time domain.

In one embodiment, any of the multiple first-type slots comprised in the first resource pool in time domain comprises multiple first-type multicarrier symbols.

In one embodiment, the first resource pool comprises multiple first-type subcarriers in frequency domain.

In one embodiment, the first resource pool comprises multiple first-type Physical Resource Blocks (PRBs) in frequency domain.

In one embodiment, any of the multiple first-type PRBs comprised in the first resource pool in frequency domain comprises multiple first-type subcarriers.

In one embodiment, the first resource pool comprises multiple first-type sub-channels in frequency domain.

In one embodiment, any of the multiple first-type sub-channels comprised in the first resource pool in frequency domain comprises multiple first-type PRBs.

In one embodiment, the first resource pool comprises multiple first-type Resource Elements (REs).

In one embodiment, any of the multiple first-type REs comprised in the first resource pool occupies a first-type multicarrier symbol in time domain, and any of the multiple first-type REs comprised in the first resource pool occupies a first-type subcarrier in frequency domain.

In one embodiment, the first resource pool comprises multiple first-type time-frequency resource blocks.

In one embodiment, any of the multiple first-type time-frequency resource blocks comprised in the first resource pool comprises multiple first-type multicarrier symbol in time domain.

In one embodiment, time-domain resources occupied by any of the multiple first-type time-frequency resource blocks comprised in the first resource pool in time domain belong to a first-type slot.

In one embodiment, any of the multiple first-type time-frequency resource blocks comprised in the first resource pool comprises at least one first-type slot in time domain.

In one embodiment, any of the multiple first-type time-frequency resource blocks comprised in the first resource pool comprises multiple first-type subcarriers in frequency domain.

In one embodiment, any of the multiple first-type time-frequency resource blocks comprised in the first resource pool comprises at least one first-type PRB in frequency domain.

In one embodiment, frequency-domain resources occupied by any of the multiple first-type time-frequency resource blocks comprised in the first resource pool in frequency domain belong to a first-type sub-channel.

In one embodiment, any of the multiple first-type time-frequency resource blocks comprised in the first resource pool comprises at least one first-type sub-channel in frequency domain.

In one embodiment, any of the multiple first-type time-frequency resource blocks comprised in the first resource pool comprises multiple REs.

In one embodiment, at least one of the multiple first-type time-frequency resource blocks comprised in the first resource pool comprises a Physical Sidelink Control Channel (PSCCH).

In one embodiment, at least one of the multiple first-type time-frequency resource blocks comprised in the first resource pool comprises a Physical Sidelink Shared Channel (PSSCH).

In one embodiment, at least one of the multiple first-type time-frequency resource blocks comprised in the first resource pool comprises a Physical Sidelink Feedback Channel (PSFCH).

In one embodiment, at least one of the multiple first-type time-frequency resource blocks comprised in the first resource pool comprises a PSCCH and a PSSCH.

In one embodiment, at least one of the multiple first-type time-frequency resource blocks comprised in the first resource pool comprises a PSCCH, a PSSCH and a PSFCH.

In one embodiment, at least one of the multiple first-type time-frequency resource blocks comprised in the first resource pool comprises a Physical Uplink Shared Channel (PUSCH).

In one embodiment, at least one of the multiple first-type time-frequency resource blocks comprised in the first resource pool comprises a Physical Downlink Shared Channel (PDSCH).

In one embodiment, the second resource pool comprises at least one resource pool.

In one embodiment, the second resource pool comprises at least one sidelink resource pool.

In one embodiment, the second resource pool comprises all or partial resources of a sidelink resource pool.

In one embodiment, the second resource pool is provided by a higher-layer signaling.

In one embodiment, the second resource pool is provided by an RRC-layer signaling.

In one embodiment, the second resource pool comprises multiple second-type multicarrier symbols in time domain.

In one embodiment, the second resource pool comprises multiple second-type slots in time domain.

In one embodiment, any of the multiple second-type slots comprised in the second resource pool in time domain comprises multiple second-type multicarrier symbols.

In one embodiment, the second resource pool comprises multiple second-type subcarriers in frequency domain.

In one embodiment, the second resource pool comprises multiple second-type PRBs in frequency domain.

In one embodiment, any of the multiple second-type PRBs comprised in the second resource pool in frequency domain comprises multiple second-type subcarriers.

In one embodiment, the second resource pool comprises multiple second-type sub-channels in frequency domain.

In one embodiment, any of the multiple second-type sub-channels comprised in the second resource pool in frequency domain comprises multiple second-type PRBs.

In one embodiment, the second resource pool comprises multiple second-type REs.

In one embodiment, any of the multiple second-type REs comprised in the second resource pool occupies a second-type multicarrier symbol in time domain, and any of the multiple second-type REs comprised in the second resource pool occupies a second-type subcarrier in frequency domain.

In one embodiment, the second resource pool comprises multiple second-type time-frequency resource blocks.

In one embodiment, any of the multiple second-type time-frequency resource blocks comprised in the second resource pool comprises multiple second-type multicarrier symbols in time domain.

In one embodiment, time-domain resources occupied by any of the multiple second-type time-frequency resource blocks comprised in the second resource pool in time domain belong to a second-type slot in the second resource pool.

In one embodiment, any of the multiple second-type time-frequency resource blocks comprised in the second resource pool comprises multiple second-type subcarriers in frequency domain.

In one embodiment, any of the multiple second-type time-frequency resource blocks comprised in the second resource pool comprises at least one second-type PRB in frequency domain.

In one embodiment, frequency-domain resources occupied by any of the multiple second-type time-frequency resource blocks comprised in the second resource pool belong to a second-type sub-channel.

In one embodiment, any of the multiple second-type time-frequency resource blocks comprised in the second resource pool comprises multiple REs.

In one embodiment, at least one of the multiple second-type time-frequency resource blocks comprised in the second resource pool comprises a PSCCH.

In one embodiment, at least one of the multiple second-type time-frequency resource blocks comprised in the second resource pool comprises a PSSCH.

In one embodiment, at least one of the multiple second-type time-frequency resource blocks comprised in the second resource pool comprises a PSFCH.

In one embodiment, at least one of the multiple second-type time-frequency resource blocks comprised in the second resource pool comprises a PSCCH and a PSSCH.

In one embodiment, at least one of the multiple second-type time-frequency resource blocks comprised in the second resource pool comprises a PSCCH, a PSSCH and a PSFCH.

In one embodiment, the second resource pool and the first resource pool are orthogonal.

In one embodiment, the second resource pool and the first resource pool are orthogonal in frequency domain.

In one embodiment, the second resource pool and the first resource pool are orthogonal in time domain.

In one embodiment, the second resource pool and the first resource pool are overlapping.

In one embodiment, the second resource pool and the first resource pool are overlapping in time domain.

In one embodiment, the second resource pool and the first resource pool are overlapping in frequency domain.

In one embodiment, the second resource pool and the first resource pool are orthogonal in frequency domain, and the second resource pool and the first resource pool are overlapping in time domain.

In one embodiment, the second resource pool and the first resource pool are Frequency Division Multiplexing (FDM).

In one embodiment, the second resource pool and the first resource pool are Time Division Multiplexing (TDM).

In one embodiment, the second resource pool and the first resource pool belong to a same carrier frequency.

In one embodiment, the second resource pool and the first resource pool respectively belong to two different carrier frequencies.

In one embodiment, the second resource pool and the first resource pool belong to a same Bandwidth Part (BWP).

In one embodiment, the second resource pool and the first resource pool respectively belong to two different BWPs.

In one embodiment, the second resource pool and the first resource pool are respectively two different resource pools in a same carrier frequency.

In one embodiment, the second resource pool and the first resource pool are respectively two different resource pools in a same BWP.

In one embodiment, a length of any second-type multicarrier symbol in the second resource pool is equal to a length of any first-type multicarrier symbol in the first resource pool.

In one embodiment, a length of any second-type multicarrier symbol in the second resource pool is not equal to a length of any first-type multicarrier symbol in the first resource pool.

In one embodiment, a length of any second-type multicarrier symbol in the second resource pool is greater than a length of any first-type multicarrier symbol in the first resource pool.

In one embodiment, a length of any second-type multicarrier symbol in the second resource pool is less than a length of any first-type multicarrier symbol in the first resource pool.

In one embodiment, a length of any second-type multicarrier symbol in the second resource pool is a multiple of a length of any first-type multicarrier symbol in the first resource pool.

In one embodiment, a length of any first-type multicarrier symbol in the first resource pool is a multiple of a length of any second-type multicarrier symbol in the second resource pool.

In one embodiment, a length of any second-type slot in the second resource pool is equal to a length of any first-type slot in the first resource pool.

In one embodiment, a length of any second-type slot in the second resource pool is not equal to a length of any first-type slot in the first resource pool.

In one embodiment, a length of any second-type slot in the second resource pool is greater than a length of any first-type slot in the first resource pool.

In one embodiment, a length of any second-type slot in the second resource pool is less than a length of any first-type slot in the first resource pool.

In one embodiment, a length of any second-type slot in the second resource pool is a multiple of a length of any first-type slot in the first resource pool.

In one embodiment, a length of any first-type slot in the first resource pool is a multiple of a length of any second-type slot in the second resource pool.

In one embodiment, any second-type SCS in the second resource pool is equal to any first-type SCS in the first resource pool.

In one embodiment, any second-type SCS in the second resource pool is not equal to any first-type SCS in the first resource pool.

In one embodiment, any second-type SCS in the second resource pool is greater than any first-type SCS in the first resource pool.

In one embodiment, any second-type SCS in the second resource pool is less than any first-type SCS in the first resource pool.

In one embodiment, any second-type SCS in the second resource pool is a multiple of any first-type SCS in the first resource pool.

In one embodiment, any first-type SCS in the first resource pool is a multiple of any second-type SCS in the second resource pool.

In one embodiment, frequency-domain resources occupied by any second-type PRB in the second resource pool are equal to frequency-domain resources occupied by any first-type PRB in the first resource pool.

In one embodiment, frequency-domain resources occupied by any second-type PRB in the second resource pool are not equal to frequency-domain resources occupied by any first-type PRB in the first resource pool.

In one embodiment, frequency-domain resources occupied by any second-type PRB in the second resource pool are greater than frequency-domain resources occupied by any first-type PRB in the first resource pool.

In one embodiment, frequency-domain resources occupied by any second-type PRB in the second resource pool are less than frequency-domain resources occupied by any first-type PRB in the first resource pool.

In one embodiment, frequency-domain resources occupied by any second-type sub-channel in the second resource pool are equal to frequency-domain resources occupied by any first-type sub-channel in the first resource pool.

In one embodiment, frequency-domain resources occupied by any second-type sub-channel in the second resource pool are not equal to frequency-domain resources occupied by any first-type sub-channel in the first resource pool.

In one embodiment, frequency-domain resources occupied by any second-type sub-channel in the second resource pool are greater than frequency-domain resources occupied by any first-type sub-channel in the first resource pool.

In one embodiment, frequency-domain resources occupied by any second-type sub-channel in the second resource pool are less than frequency-domain resources occupied by any first-type sub-channel in the first resource pool.

In one embodiment, a number of second-type PRB(s) comprised in any second-type sub-channel in the second resource pool is equal to a number of first-type PRB(s) comprised in any first-type sub-channel in the first resource pool.

In one embodiment, a number of second-type PRB(s) comprised in any second-type sub-channel in the second resource pool is not equal to a number of first-type PRB(s) comprised in any first-type sub-channel in the first resource pool.

In one embodiment, a number of second-type PRB(s) comprised in any second-type sub-channel in the second resource pool is greater than a number of first-type PRB(s) comprised in any first-type sub-channel in the first resource pool.

In one embodiment, a number of second-type PRB(s) comprised in any second-type sub-channel in the second resource pool is less than a number of first-type PRB(s) comprised in any first-type sub-channel in the first resource pool.

In one embodiment, the first signal comprises a baseband signal.

In one embodiment, the first signal comprises a radio-frequency signal.

In one embodiment, the first signal comprises a radio signal.

In one embodiment, the first signal comprises a packet.

In one embodiment, the first signal comprises SL data.

In one embodiment, the first signal comprises available data in one or multiple logical channels.

In one embodiment, the first signal comprises available SL data in one or multiple logical channels.

In one embodiment, the first signal comprises one or multiple MAC Protocol Data Units (PDUs).

In one embodiment, the first signal comprises one or multiple MAC Service Data Units (SDUs).

In one embodiment, the first signal comprises one or multiple TBs.

In one embodiment, the first signal comprises one Transport Block (TB).

In one embodiment, the first signal comprises all or part of a higher-layer signaling.

In one embodiment, the first signal comprises all or part of a Radio Resource Control (RRC) layer signaling.

In one embodiment, the first signal comprises all or part of a Multimedia Access Control (MAC) layer signaling.

In one embodiment, the first signal is transmitted on a PSCCH.

In one embodiment, the first signal is transmitted on a PSSCH.

In one embodiment, the first signal is transmitted on a PSCCH and ?a PSSCH.

In one embodiment, a transmission of the first signal is unicast.

In one embodiment, a transmission of the first signal is groupcast.

In one embodiment, the first signal comprises a first bit block, and the first bit block comprises at least one bit.

In one embodiment, the first signal carries a first bit block, and the first bit block comprises at least one bit.

In one embodiment, the first bit block is used to generate the first signal.

In one embodiment, the first bit block in the first signal is transmitted on a PSSCH.

In one embodiment, the first bit block is from a Sidelink Shared Channel (SL-SCH).

In one embodiment, the first bit block comprises one Codeword (CW).

In one embodiment, the first bit block comprises one Code Block (CB).

In one embodiment, the first bit block comprises one Code Block Group (CBG).

In one embodiment, the first bit block comprises one Trandport Block (TB).

In one embodiment, the first bit block comprises one MAC PDU.

In one embodiment, the first bit block comprises multiple MAC PDUs.

In one embodiment, the first signal is obtained after all or partial bits of the first bit block are sequentially subjected to transport block-level Cyclic Redundancy Check (CRC) attachment, Code Block Segmentation, code block-level CRC attachment, Channel Coding, Rate Matching, Code Block Concatenation, Scrambling, Modulation, Layer Mapping, Antenna Port Mapping, Mapping to Physical Resource Blocks, Baseband Signal Generation, Modulation and Upconversion.

In one embodiment, the first signal is an output after the first bit block is sequentially subjected to a modulation mapper, a layer mapper, precoding, a resource element mapper, and multi-carrier symbol generation.

In one embodiment, the channel coding is based on a polar code.

In one embodiment, the channel coding is based on a Low-density Parity-Check (LDPC) code.

In one embodiment, the first signal comprises a first sub-signaling.

In one embodiment, the first signal comprises a first sub-signaling and the first bit block.

In one embodiment, the first sub-signaling in the first signal is transmitted on a PSCCH.

In one embodiment, the first sub-signaling in the first signal is transmitted on a PSSCH.

In one embodiment, the first sub-signaling in the first signal and the first bit block are respectively transmitted on a PSCCH and a PSSCH.

In one embodiment, both the first sub-signaling in the first signal and the first bit block are respectively transmitted on a PSSCH.

In one embodiment, the first sub-signaling in the first signal is used to schedule the first bit block in the first signal.

In one embodiment, the first sub-signaling in the first signal indicates time-frequency resources occupied by the first signal.

In one embodiment, the first sub-signaling in the first signal indicates time-frequency resources occupied by the first signal, and time-frequency resources occupied by the first signal are the first time-frequency resource block.

In one embodiment, the first sub-signaling in the first signal indicates a Modulation and Coding Scheme (MCS) went through by the first bit block.

In one embodiment, the first sub-signaling in the first signal indicates a Demodulation Reference Signal (DMRS) adopted by the first signal.

In one embodiment, the first signal carries a first priority.

In one embodiment, the first sub-signaling in the first signal indicates the first priority.

In one embodiment, the first sub-signaling in the first signal indicates the first priority, and the first priority is a priority of the first bit block in the first signal.

In one embodiment, the first sub-signaling in the first signal is an SCI (Sidelink Control Information).

In one embodiment, the first sub-signaling in the first signal is an SCI, and the first bit block in the first signal is a TB.

In one embodiment, the first priority is equal to a positive integer.

In one embodiment, the first priority is a positive integer from 1 to P, and P is a positive integer greater than 1.

In one embodiment, P is equal to 8.

In one embodiment, the first information comprises Hybrid Automatic Repeat reQuest (HARQ) information.

In one embodiment, the first information is HARQ information.

In one embodiment, the first information comprises Acknowledge (ACK).

In one embodiment, the first information comprises Negative Acknowledge (NACK).

In one embodiment, the first information only comprises NACK.

In one embodiment, the first information comprises one of ACK or NACK.

In one embodiment, the first information comprises HARQ-ACK information.

In one embodiment, the first information comprises HARQ-NACK information.

In one embodiment, the first information comprises one of HARQ-ACK or HARQ-NACK information.

In one embodiment, the first information only comprises HARQ-NACK information.

In one embodiment, the first information comprises Conflict Information.

In one embodiment, the first information comprises one or multiple RRC Information Elements (IEs).

In one embodiment, the first information comprises one or multiple MAC Control Elements (CEs).

In one embodiment, the first information block is used to generate one or multiple Physical (PHY) Layer signalings.

In one embodiment, the first information is transmitted on the target time-frequency resource block.

In one embodiment, the first information is transmitted on a PSFCH.

In one embodiment, the first information is transmitted on the PSCCH.

In one embodiment, the first information is transmitted on a PSSCH.

In one embodiment, the first signal is transmitted on a PSSCH, and the first information is transmitted on a PSFCH.

In one embodiment, the first signal is transmitted on a PSCCH and a PSSCH, and the first information is transmitted on a PSFCH.

In one embodiment, the first information is used to indicate whether the first signal is correctly received.

In one embodiment, the first information is used to indicate that the first signal is correctly received.

In one embodiment, the first information is used to indicate that the first signal is not correctly received.

In one embodiment, the first information is used to indicate whether the first signal is correctly received by the first node.

In one embodiment, the first information is used to indicate that the first signal is correctly received by the first node.

In one embodiment, the first information is used to indicate that the first signal is not correctly received by the first node.

In one embodiment, when the first signal is correctly received by the first node, the first information comprises HARQ-ACK information; when the first signal is not correctly received by the first node, the first information comprises HARQ-NACK information.

In one embodiment, when the first signal is correctly received by the first node, the first node drops transmitting the first information; when the first signal is not correctly received by the first node, the first information comprises HARQ-NACK information.

In one embodiment, the first information is used to indicate resource conflict.

In one embodiment, “as a response to receiving the first signal, transmitting first information on a target time-frequency resource block” refers to after the first signal is received, the first information is transmitted on the target time-frequency resource block.

In one embodiment, transmitting the first information on the target time-frequency resource block occurs after the first signal is received.

In one embodiment, the first sub-signaling in the first signal is correctly received, a first bit block in the first signal is not correctly received, the first node transmits the first information on the target time-frequency resource block, and the first information comprises HARQ-NACK information.

In one embodiment, the first sub-signaling in the first signal is correctly received, a first bit block in the first signal is also correctly received, the first node transmits the first information on the target time-frequency resource block, and the first information comprises HARQ-NACK information.

In one embodiment, the first signal being correctly received refers to: both the first sub-signaling in the first signal and the first bit block are correctly received.

In one embodiment, the first signal not being correctly received refers to: the first sub-signaling in the first signal is correctly received, and the first bit block in the first signal is not correctly received.

In one embodiment, the first signal not being correctly received comprises: the first sub-signaling in the first signal not being correctly received.

In one embodiment, the first signal being not correctly received comprises: the first bit block in the first signal not being correctly received.

In one embodiment, the being correctly received comprises: executing channel decoding on a radio signal, and a result of the performing channel decoding on a radio signal passing CRC check.

In one embodiment, the being correctly received comprises: executing energy detection on the radio signal in a duration, and an average value of a result of the executing energy detection on the radio signal in the duration exceeding a first given threshold.

In one embodiment, the being correctly received comprises: executing a coherent detection on the radio signal, and signal energy obtained from the executing coherent detection on the radio signal exceeding a given threshold.

In one embodiment, the first signal being correctly received comprises: a result of executing channel decoding on the first bit block in the first signal passing CRC check, and the first bit block being used to generate the first signal.

In one embodiment, the first signal being correctly received comprises: a result of performing channel decoding on the first sub-signaling in the first signal passing a CRC check.

In one embodiment, the first signal being correctly received comprises: performing a coherent detection on the first sub-signaling in the first signal, and signal energy obtained by performing a coherent detection on the first sub-signaling exceeding the given threshold.

In one embodiment, the first signal not being correctly received comprises: a result of executing channel decoding on the first bit block in the first signal not passing a CRC check, and the first bit block being used to generate the first signal.

In one embodiment, the first signal not being correctly received comprises: a result of channel decoding performed on the first sub-signaling in the first signal not passing a CRC check.

In one embodiment, the first signal not being correctly received comprises: performing a coherent detection on the first sub-signaling in the first signal, and signal energy obtained by performing a coherent detection on the first sub-signaling not exceeding the given threshold.

In one embodiment, any of the multiple first-type multicarrier symbols comprised in the first resource pool is a Single-Carrier Frequency Division Multiple Access (SC-FDMA) symbol.

In one embodiment, any of the multiple first-type multicarrier symbols comprised in the first resource pool is a Discrete Fourier Transform Spread Orthogonal Frequency Division Multiplexing (DFT-S-OFDM) symbol.

In one embodiment, any of the multiple first-type multicarrier symbols comprised in the first resource pool is a Frequency Division Multiple Access (FDMA) symbol.

In one embodiment, any of the multiple first-type multicarrier symbols comprised in the first resource pool is a Filter Bank Multi-Carrier (FBMC) symbol.

In one embodiment, any of the multiple first-type multicarrier symbols comprised in the first resource pool is an Interleaved Frequency Division Multiple Access (IFDMA) symbol.

In one embodiment, any of the multiple second-type multicarrier symbols comprised in the second resource pool is an SC-FDMA symbol.

In one embodiment, any of the multiple second-type multicarrier symbols comprised in the second resource pool is a DFT-S-OFDM symbol.

In one embodiment, any of the multiple first-type multicarrier symbols comprised in the second resource pool is an FDMA symbol.

In one embodiment, any of the multiple first-type multicarrier symbols comprised in the second resource pool is an FBMC symbol.

In one embodiment, any of the multiple first-type multicarrier symbols comprised in the second resource pool is an IFDMA symbol.

In one embodiment, any first-type multicarrier symbol in the first resource pool is an SC-FDMA symbol, and any second-type multicarrier symbol in the second resource pool is a DFT-S-OFDM symbol.

In one embodiment, any first-type multicarrier symbol in the first resource pool is an SC-FDMA symbol, and any second-type multicarrier symbol in the second resource pool is an FDMA symbol.

In one embodiment, any first-type multicarrier symbol in the first resource pool is an FDMA symbol, and any second-type multicarrier symbol in the second resource pool is an SC-FDMA symbol.

### Embodiment 2

Embodiment 2 illustrates a schematic diagram of a network architecture according to the present application, as shown in FIG. 2. FIG. 2 illustrates a network architecture 200 of 5G NR, Long-Term Evolution (LTE) and Long-Term Evolution Advanced (LTE-A) systems. The 5G NR or LTE network architecture 200 may be called a 5G System (5GS)/Evolved Packet System (EPS) 200 or other appropriate terms. The 5GS/EPS 200 may comprise one or more UEs 201, a UE 241 that is in Sidelink communications with a UE 201, an NG-RAN 202, a 5G-Core Network/Evolved Packet Core (5GC/EPC) 210, a Home Subscriber Server (HSS)/Unified Data Management (UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will readily understand that various concepts presented throughout the present application can be extended to networks providing circuit switching services or other cellular networks. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. In NTN networks, examples of gNB 203 include satellites, aircrafts, or ground base stations relayed through satellites. The gNB 203 provides an access point of the 5GC/EPC 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPS), multimedia devices, video devices, digital audio players (for example, MP3 players), cameras, game consoles, unmanned aerial vehicles (UAV), aircrafts, narrow-band Internet of Things (loT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the first node in the present application comprises the UE 201.

In one embodiment, the second node in the present application comprises the UE 241.

In one embodiment, the UE in the present application comprises the UE 201.

In one embodiment, the UE in the present application comprises the UE 241.

In one embodiment, a transmitter of first information in the present application comprises the UE 201.

In one embodiment, a receiver of first information in the present application comprises the UE 241.

In one embodiment, a receiver of a first signal in the present application comprises the UE 201.

In one embodiment, a transmitter of a first signal in the present application comprises the UE 241.

### Embodiment 3

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 between a first node (UE or RSU in V2X, vehicle equipment or On-Board Communication Unit) and a second node (gNB, UE or RSU in V2X, vehicle equipment or On-Board Communication Unit), or between two UEs is represented by three layers, which are respectively layer 1, layer 2 and layer 3. The layer 1 (L1) is the lowest layer and performs signal processing functions of various PHY layers. The L1 is called PHY 301 in the present application. The layer 2 (L2) 305 is above the PHY 301, and is in charge of the link between the first node and the second node, and between two UEs via the PHY 301. The L2 305 comprises a Medium Access Control (MAC) sublayer 302, a Radio Link Control (RLC) sublayer 303 and a Packet Data Convergence Protocol (PDCP) sublayer 304. All the three sublayers terminate at the second nodes. The PDCP sublayer 304 provides data encryption and integrity protection and provides support for handover of a first node between second nodes. The RLC sublayer 303 provides segmentation and reassembling of a packet, retransmission of a lost data packet through ARQ, as well as repeat data packet detection and protocol error detection. The MAC sublayer 302 provides mapping between a logic channel and a transport channel and multiplexing of the logical channel. The MAC sublayer 302 is also responsible for allocating between first nodes various radio resources (i.e., resource block) in a cell. The MAC sublayer 302 is also responsible for HARQ operations. In the control plane 300, the RRC sublayer 306 in the L3 layer is responsible for acquiring radio resources (i.e., radio bearer) and configuring the lower layer using an RRC signaling between the second node and the first node. The radio protocol architecture in the user plane 350 comprises the L1 layer and the L2 layer. In the user plane 350, the radio protocol architecture used for the first communication node and the second communication node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in FIG. 3, the first node may comprise several higher layers above the L2 305, such as a network layer (i.e., IP layer) terminated at a P-GW of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first signal in the present application is generated by the MAC sublayer 302.

In one embodiment, the first signal in the present application is generated by the RRC sublayer 306.

In one embodiment, the first signal in the present application is transmitted to the PHY 301 via the MAC sublayer 302.

In one embodiment, the first information in the present application is generated by the PHY 301.

In one embodiment, the first information in the present application is generated by the MAC sublayer 302.

In one embodiment, the first information in the present application is transmitted to the PHY 301 via the MAC sublayer 302.

### Embodiment 4

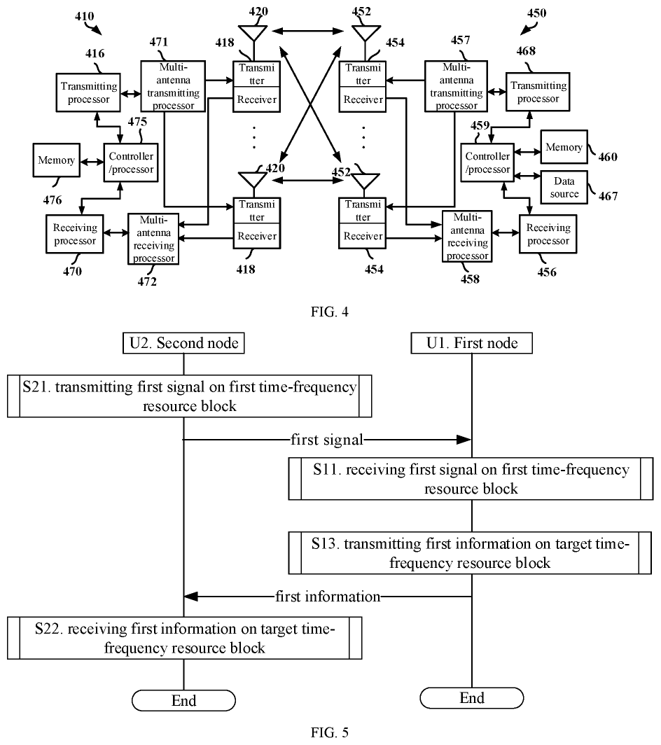

Embodiment 4 illustrates a schematic diagram of a first communication device and a second communication device in the present application, as shown in FIG. 4. FIG. 4 is a block diagram of a first communication device 410 in communication with a second communication device 450 in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from the core network is provided to a controller/processor 475. The controller/processor 475 provides a function of the L2 layer. In the transmission from the first communication device 410 to the first communication device 450, the controller/processor 475 provides header compression, encryption, packet segmentation and reordering, and multiplexing between a logical channel and a transport channel, and radio resources allocation to the second communication device 450 based on various priorities. The controller/processor 475 is also responsible for retransmission of a lost packet and a signaling to the second communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 450, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the second communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the first communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the first communication device 410 to the second communication device 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in the transmission from the first communication device 410 to the second communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the first communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the second communication device 450 to the first communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first node in the present application comprises the second communication device 450, and the second node in the present application comprises the first communication device 410.

In one subembodiment of the above embodiment, the first node is a UE, and the second node is a UE.

In one subembodiment of the above embodiment, the first node is a UE, and the second node is a relay node.

In one subembodiment of the above embodiment, the first node is a relay node, and the second node is a UE.

In one subembodiment of the above embodiment, the first node is a relay node, and the second node is a relay node.

In one subembodiment of the above embodiment, the second communication device 450 comprises: at least one controller/processor; the at least one controller/processor is responsible for HARQ operation.

In one subembodiment of the above embodiment, the first communication device 410 comprises: at least one controller/processor; the at least one controller/processor is responsible for HARQ operation.

In one subembodiment of the above embodiment, the first communication device 410 comprises: at least one controller/processor; the at least one controller/processor is responsible for error detection using ACK and/or NACK protocols as a way to support HARQ operation.

In one embodiment, the second communication device 450 comprises at least one processor and at least one memory. The at least one memory comprises computer program codes; the at least one memory and the computer program codes are configured to be used in collaboration with the at least one processor. The second communication device 450 at least: receives a first signal on a first time-frequency resource block; as a response to receiving the first signal, transmits first information on a target time-frequency resource block, the first information is used to indicate whether the first signal is correctly received; a first resource pool comprises a first time-frequency resource group, the first time-frequency resource group comprises at least one first-type time-frequency resource block, and the first time-frequency resource block is a first-type time-frequency resource block in the first time-frequency resource group; the first resource pool comprises multiple first-type slots in time domain, and time-domain resources occupied by any first-type time-frequency resource block in the first time-frequency resource group in time domain belong to a first-type slot in the first resource pool; time-domain resources occupied by the first time-frequency resource group in time domain are not greater than a first equivalent period, and the first equivalent period comprises at least one first-type slot; a second resource pool comprises multiple candidate resource sets, a second period is a time interval between any two adjacent candidate resource sets in time domain among the multiple candidate resource sets, a target resource set is one of the multiple candidate resource sets, the target resource set comprises multiple third-type time-frequency resource blocks, and the target time-frequency resource block is a third-type time-frequency resource block in the target resource set; the first time-frequency resource block is associated with the target time-frequency resource block; the second resource pool comprises multiple second-type slots in time domain, the second period comprises at least one second-type slot, and the first equivalent period is related to the second period.

In one embodiment, the second communication device 450 comprises a memory that stores a computer readable instruction program. The computer readable instruction program generates an action when executed by at least one processor. The action includes: receiving a first signal on a first time-frequency resource block; as a response to receiving the first signal, transmitting first information on a target time-frequency resource block, the first information being used to indicate whether the first signal is correctly received; a first resource pool comprises a first time-frequency resource group, the first time-frequency resource group comprises at least one first-type time-frequency resource block, and the first time-frequency resource block is a first-type time-frequency resource block in the first time-frequency resource group; the first resource pool comprises multiple first-type slots in time domain, and time-domain resources occupied by any first-type time-frequency resource block in the first time-frequency resource group in time domain belong to a first-type slot in the first resource pool; time-domain resources occupied by the first time-frequency resource group in time domain are not greater than a first equivalent period, and the first equivalent period comprises at least one first-type slot; a second resource pool comprises multiple candidate resource sets, a second period is a time interval between any two adjacent candidate resource sets in time domain among the multiple candidate resource sets, a target resource set is one of the multiple candidate resource sets, the target resource set comprises multiple third-type time-frequency resource blocks, and the target time-frequency resource block is a third-type time-frequency resource block in the target resource set; the first time-frequency resource block is associated with the target time-frequency resource block; the second resource pool comprises multiple second-type slots in time domain, the second period comprises at least one second-type slot, and the first equivalent period is related to the second period.

In one embodiment, the first communication device 410 comprises at least one processor and at least one memory. The at least one memory comprises computer program codes; the at least one memory and the computer program codes are configured to be used in collaboration with the at least one processor. The first communication device 410 at least: transmits a first radio signal in a first time-domain resource block; receives first information on a target time-frequency resource block, the first information is used to indicate whether the first signal is correctly received; a first resource pool comprises a first time-frequency resource group, the first time-frequency resource group comprises at least one first-type time-frequency resource block, and the first time-frequency resource block is a first-type time-frequency resource block in the first time-frequency resource group; the first resource pool comprises multiple first-type slots in time domain, and time-domain resources occupied by any first-type time-frequency resource block in the first time-frequency resource group in time domain belong to a first-type slot in the first resource pool; time-domain resources occupied by the first time-frequency resource group in time domain are not greater than a first equivalent period, and the first equivalent period comprises at least one first-type slot; a second resource pool comprises multiple candidate resource sets, a second period is a time interval between any two adjacent candidate resource sets in time domain among the multiple candidate resource sets, a target resource set is one of the multiple candidate resource sets, the target resource set comprises multiple third-type time-frequency resource blocks, and the target time-frequency resource block is a third-type time-frequency resource block in the target resource set; the first time-frequency resource block is associated with the target time-frequency resource block; the second resource pool comprises multiple second-type slots in time domain, the second period comprises at least one second-type slot, and the first equivalent period is related to the second period.

In one embodiment, the first communication device 410 comprises a memory that stores a computer readable instruction program. The computer readable instruction program generates an action when executed by at least one processor. The action includes: transmitting a first signal on a first time-frequency resource block; receiving first information on a target time-frequency resource block, the first information being used to indicate whether the first signal is correctly received; a first resource pool comprises a first time-frequency resource group, the first time-frequency resource group comprises at least one first-type time-frequency resource block, and the first time-frequency resource block is a first-type time-frequency resource block in the first time-frequency resource group; the first resource pool comprises multiple first-type slots in time domain, and time-domain resources occupied by any first-type time-frequency resource block in the first time-frequency resource group in time domain belong to a first-type slot in the first resource pool; time-domain resources occupied by the first time-frequency resource group in time domain are not greater than a first equivalent period, and the first equivalent period comprises at least one first-type slot; a second resource pool comprises multiple candidate resource sets, a second period is a time interval between any two adjacent candidate resource sets in time domain among the multiple candidate resource sets, a target resource set is one of the multiple candidate resource sets, the target resource set comprises multiple third-type time-frequency resource blocks, and the target time-frequency resource block is a third-type time-frequency resource block in the target resource set; the first time-frequency resource block is associated with the target time-frequency resource block; the second resource pool comprises multiple second-type slots in time domain, the second period comprises at least one second-type slot, and the first equivalent period is related to the second period.

In one embodiment, at least one of the antenna 452, the receiver 454, the multi-antenna receiving processor 458, the receiving processor 456, the controller/processor 459, the memory 460, or the data source 467 is used to receive N first signals on a first time-frequency resource block in the present application.

In one embodiment, at least one of the antenna 452, the transmitter 454, the multi-antenna transmitting processor 457, the transmitting processor 468, the controller/processor 459, the memory 460, or the data sources 467 is used to transmit first information in the present application;

In one embodiment, at least one of the antenna 420, the transmitter 418, the multi-antenna transmitting processor 471, the transmitting processor 416, the controller/processor 475, or the memory 476 is used to transmit a first signal on a first time-frequency resource block in the present application.

In one embodiment, at least one of the antenna 420, the receiver 418, the multi-antenna receiving processor 472, the receiving processor 470, the controller/processor 475, or the memory 476 is used to receive first information on a target time-frequency resource block in the present application.

### Embodiment 5

Embodiment 5 illustrates a flowchart of radio signal transmission according to one embodiment in the present application, as shown in FIG. 5. In FIG. 5, a first node U1 and a second node U2 are in communications via an air interface.

The first node U1 receives a first signal on a first time-frequency resource block in step S11; as a response to receiving the first signal, transmits first information on a target time-frequency resource block in step S12.

The second node U2 transmits a first signal on a first time-frequency resource block in step S21; receives first information on a target time-frequency resource block in step S22.

In embodiment 5, a first resource pool comprises a first time-frequency resource group, the first time-frequency resource group comprises at least one first-type time-frequency resource block, and the first time-frequency resource block is a first-type time-frequency resource block in the first time-frequency resource group; the first resource pool comprises multiple first-type slots in time domain, and time-domain resources occupied by any first-type time-frequency resource block in the first time-frequency resource group in time domain belong to a first-type slot in the first resource pool; time-domain resources occupied by the first time-frequency resource group in time domain are not greater than a first equivalent period, and the first equivalent period comprises at least one first-type slot; a second resource pool comprises multiple candidate resource sets, a second period is a time interval between any two adjacent candidate resource sets in time domain among the multiple candidate resource sets, a target resource set is one of the multiple candidate resource sets, the target resource set comprises multiple third-type time-frequency resource blocks, and the target time-frequency resource block is a third-type time-frequency resource block in the target resource set; the first time-frequency resource block is associated with the target time-frequency resource block; the second resource pool comprises multiple second-type slots in time domain, and time-domain resources occupied by any third-type time-frequency resource block in the target resource set in time domain belong to a second-type slot in the second resource pool; the second period comprises at least one second-type slot, and the first equivalent period is related to the second period; the first resource pool comprises multiple first-type sub-channels in frequency domain; the first time-frequency resource block occupies at least one of the multiple first-type sub-channels in frequency domain; a number of the multiple first-type sub-channels comprised in the first resource pool in frequency domain and the first equivalent period are used to determine a number of all first-type time-frequency resource block(s) in the first time-frequency resource group; the second resource pool comprises a second time-frequency resource group, and the second time-frequency resource group comprises multiple second-type time-frequency resource blocks; any second-type time-frequency resource block in the second time-frequency resource group occupies a second-type slot in the second resource pool in time domain; the target resource set comprises a first target resource subset and a second target resource subset, the first target resource subset is associated with the first time-frequency resource group, and the second target resource subset is associated with the second time-frequency resource group; a first frequency-domain offset is used to determine frequency-domain resources occupied by the target resource set in the second resource pool; all the multiple third-type time-frequency resource blocks comprised in the target resource set belong to a target slot in time domain, and the target slot is a second-type slot in the second resource pool; a time interval between a first-type slot occupied by the first time-frequency resource block in the first resource pool and the target slot is not less than a minimum time interval.

In one embodiment, the first equivalent period is related to both a length of a first-type slot in the first resource pool and a length of a second-type slot in the second resource pool.

In one embodiment, the first resource pool comprises multiple first-type time-frequency resource blocks, any first-type time-frequency resource block in the first resource pool comprises multiple first-type subcarriers in frequency domain, the second resource pool comprises multiple second-type time-frequency resource blocks, and any second-type time-frequency resource block in the second resource pool comprises multiple second-type subcarriers in frequency domain; the first equivalent period is related to both an SCS of any first-type subcarrier in the first resource pool and an SCS of any second-type subcarrier in the second resource pool.

In one embodiment, the first node U1 and the second node U2 are in communications via a PC5 interface.

In one embodiment, the first resource pool is provided by a higher layer of the first node U1 to a physical layer of the first node U1.

In one embodiment, the second resource pool is provided by a higher layer of the first node U1 to a physical layer of the first node U1.

In one embodiment, the first resource pool is provided by a higher layer of the second node U2 to a physical layer of the second node U2.

In one embodiment, the second resource pool is provided by a higher layer of the second node U2 to a physical layer of the second node U2.

In one embodiment, a higher layer of the first node U1 comprises at least one of an RRC layer of the first node U1 or a MAC layer of the first node U1.

In one embodiment, a higher layer of the first node U1 comprises an RRC layer of the first node U1.

In one embodiment, a higher layer of the first node U1 comprises a MAC layer of the first node U1.

In one embodiment, a higher layer of the first node U1 comprises an RRC layer of the first node U1 and a MAC layer of the first node U1.

In one embodiment, a physical layer of the first node U1 comprises a PHY layer of the first node U1.

In one embodiment, a higher layer of the first node U1 comprises at least one of an RRC layer of the second node U2 or a MAC layer of the second U2.

In one embodiment, a higher layer of the second node U2 comprises an RRC layer of the second node U2.

In one embodiment, a higher layer of the second node U2 comprises a MAC layer of the second node U2.

In one embodiment, a higher layer of the second node U2 comprises an RRC layer of the second node U2 and a MAC layer of the first node U1.

In one embodiment, a physical layer of the second node U2 comprises a PHY layer of the second node U2.

In one embodiment, the first time-frequency resource block is determined by the second node U2 itself.

In one embodiment, the first time-frequency resource block is determined by the second node U2 itself from the first time-frequency resource group.

### Embodiment 6

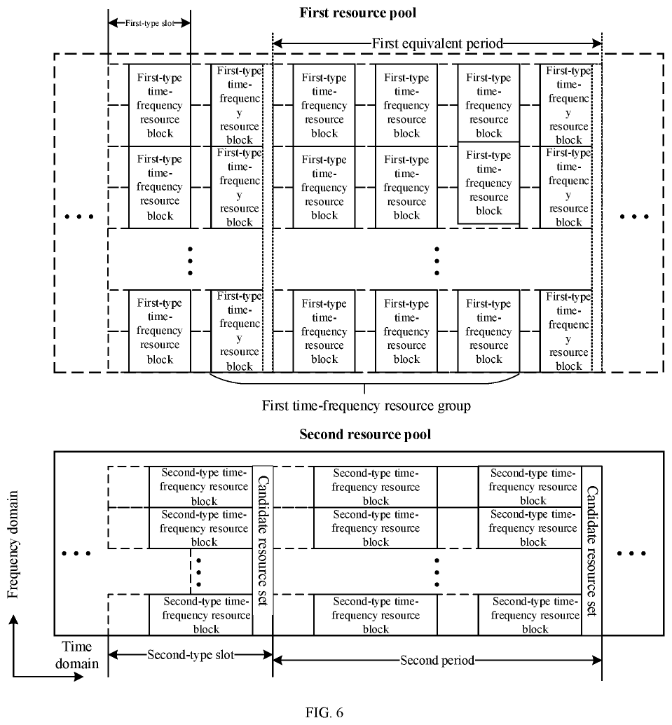

Embodiment 6 illustrates a schematic diagram of relations among a first resource pool, a second resource pool, a first-type slot, a second-type slot, a first time-frequency resource group, a first equivalent period and a second period according to one embodiment of the present application, as shown in FIG. 6. In FIG. 6, the big dashed rectangle represents a first resource pool in the present application, and the big solid rectangle represents a second resource pool in the present application; the solid rectangle in the first resource pool represents a first-type time-frequency resource block in the present application; the solid wide rectangle in the second resource pool represents a second-type time-frequency resource block in the present application; the solid narrow rectangle in the second resource pool represents a candidate resource set in the present application.

In embodiment 6, the first resource pool comprises multiple first-type time-frequency resource blocks, the first resource pool comprises multiple first-type slots in time domain, and time-domain resources occupied by any first-type time-frequency resource block in the first resource pool in time domain belong to a first-type slot in the first resource pool; the second resource pool comprises multiple second-type time-frequency resource blocks, the second resource pool comprises multiple second-type slots in time frequency, and time-domain resources occupied by any second-type time-frequency resource block in the second resource pool in time domain belong to a second-type slot in the second resource pool; the first resource pool comprises the first time-frequency resource group, and the first time-frequency resource group comprises at least one first-type time-frequency resource block; time-domain resources occupied by the first time-frequency resource group in time domain are not greater than the first equivalent period, the first equivalent period comprises at least one first-type slot in the first resource pool, the second period comprises at least one second-type slot in the second resource pool, and the first equivalent period is related to the second period.

In one embodiment, the first resource pool comprises the first time-frequency resource group.

In one embodiment, the first time-frequency resource group belongs to the first resource pool.

In one embodiment, the first time-frequency resource group comprises at least one first-type time-frequency resource block.

In one embodiment, the first time-frequency resource group comprises at least one first-type time-frequency resource block in the first resource pool.

In one embodiment, the first time-frequency resource group comprises at least one first-type time-frequency resource block, and any first-type time-frequency resource block in the first time-frequency resource group is a first-type time-frequency resource block in the first resource pool.

In one embodiment, time-domain resources occupied by the first time-frequency resource group in time domain are not greater than the first equivalent period.

In one embodiment, time-domain resources occupied by the first time-frequency resource group in time domain are equal to the first equivalent period.

In one embodiment, time-domain resources occupied by the first time-frequency resource group in time domain are less than the first equivalent period.

In one embodiment, time-domain resources occupied by all first-type time-frequency resource blocks in the first time-frequency resource group in time domain are not greater than the first equivalent period.

In one embodiment, time-domain resources occupied by all first-type time-frequency resource blocks in the first time-frequency resource group in time domain are equal to the first equivalent period.

In one embodiment, time-domain resources occupied by all first-type time-frequency resource blocks in the first time-frequency resource group in time domain are less than the first equivalent period.

In one embodiment, the first time-frequency resource group is related to the first equivalent period.

In one embodiment, the first time-frequency resource group is related to the second period.

In one embodiment, time-domain resources occupied by the first time-frequency resource group in time domain are related to the first equivalent period.

In one embodiment, time-domain resources occupied by the first time-frequency resource group in time domain are related to the second period.

In one embodiment, a number of the at least one first-type time-frequency resource block comprised in the first time-frequency resource group is related to the first equivalent period.

In one embodiment, a number of the at least one first-type time-frequency resource block comprised in the first time-frequency resource group is related to the second period.

In one embodiment, the first equivalent period is used to determine the first time-frequency resource group.

In one embodiment, the second period is used to determine the first time-frequency resource group.

In one embodiment, the first equivalent period is used to determine a number of the at least one first-type time-frequency resource block comprised in the first time-frequency resource group.

In one embodiment, the second period is used to determine a number of the at least one first-type time-frequency resource block comprised in the first time-frequency resource group.

In one embodiment, the first equivalent period is used to determine time-domain resources occupied by the first time-frequency resource group in time domain.

In one embodiment, the second period is used to determine time-domain resources occupied by the first time-frequency resource group in time domain.

In one embodiment, the first equivalent period is used to determine a number of the first-type slot(s) occupied by the first time-frequency resource group in time domain.

In one embodiment, the second period is used to determine a number of the first-type slot(s) occupied by the first time-frequency resource group in time domain.

In one embodiment, a number of all first-type time-frequency resource blocks in the first time-frequency resource group is related to both a number of the multiple first-type sub-channels comprised in the first resource pool in frequency domain and the first equivalent period.

In one embodiment, a number of all first-type time-frequency resource blocks in the first time-frequency resource group is related to a product of a number of the multiple first-type sub-channels comprised in the first resource pool in frequency domain and a number of all first-type slots comprised in the first equivalent period.

In one embodiment, a number of all first-type time-frequency resource blocks in the first time-frequency resource group is not greater than a product of a number of the multiple first-type sub-channels comprised in the first resource pool in frequency domain and a number of all first-type slots comprised in the first equivalent period.

In one embodiment, a number of all first-type time-frequency resource blocks in the first time-frequency resource group is equal to a product of a number of the multiple first-type sub-channels comprised in the first resource pool in frequency domain and a number of all first-type slots comprised in the first equivalent period.

In one embodiment, a number of the multiple first-type sub-channels comprised in the first resource pool in frequency domain and the first equivalent period are used to determine a number of all first-type time-frequency resource block(s) in the first time-frequency resource group.

In one embodiment, a number of the multiple first-type sub-channels comprised in the first resource pool in frequency domain and a number of all first-type slots comprised in the first equivalent period are used to determine a number of all first-type time-frequency resource block(s) in the first time-frequency resource group.

In one embodiment, the first equivalent period is a time interval.

In one embodiment, the first resource pool comprises multiple equivalent candidate resource sets, and the first equivalent period is a time interval between any two adjacent equivalent candidate resource sets in time domain among the multiple equivalent candidate resource sets.

In one embodiment, the first equivalent period is related to a length of any first-type slot in the first resource pool.

In one embodiment, the first equivalent period is not less than a length of any first-type slot in the first resource pool.

In one embodiment, the first equivalent period is equal to a multiple of a length of any first-type slot in the first resource pool.

In one embodiment, the first equivalent period is related to a length of any second-type slot in the second resource pool.

In one embodiment, the first equivalent period is not less than a length of any second-type slot in the second resource pool.

In one embodiment, the first equivalent period is equal to a multiple of a length of any second-type slot in the second resource pool.

In one embodiment, the first equivalent period is related to both a length of any first-type slot in the first resource pool and a length of any second-type slot in the second resource pool.

In one embodiment, the first equivalent period is not less than a greater value between a length of any first-type slot in the first resource pool and a length of any second-type slot in the second resource pool.

In one embodiment, the first equivalent period is equal to a multiple of a greater value between a length of any first-type slot in the first resource pool and a length of any second-type slot in the second resource pool.

In one embodiment, the first equivalent period is related to an SCS of any first-type subcarrier in the first resource pool.

In one embodiment, the first equivalent period is related to an SCS of any second-type subcarrier in the second resource pool.

In one embodiment, the first equivalent period is related to an SCS of any first-type subcarrier in the first resource pool and an SCS of any second-type subcarrier in the second resource pool.

In one embodiment, the first resource pool comprises multiple first-type time-frequency resource blocks, any first-type time-frequency resource block in the first resource pool comprises multiple first-type subcarriers in frequency domain, the second resource pool comprises multiple second-type time-frequency resource blocks, and any second-type time-frequency resource block in the second resource pool comprises multiple second-type subcarriers in frequency domain; the first equivalent period is related to both an SCS of any first-type subcarrier in the first resource pool and an SCS of any second-type subcarrier in the second resource pool.

In one embodiment, a length of any first-type slot in the first resource pool is related to an SCS of any first-type subcarrier in the first resource pool, and the first equivalent period is related to a length of any first-type slot in the first resource pool.

In one embodiment, a length of any second-type slot in the second resource pool is related to an SCS of any second-type subcarrier in the second resource pool, and the first equivalent period is related to a length of any second-type slot in the second resource pool.

In one embodiment, a length of any first-type slot in the first resource pool is related to an SCS of any first-type subcarrier in the first resource pool, a length of any second-type slot in the second resource pool is related to an SCS of any second-type subcarrier in the second resource pool, and the first equivalent period is related to both a length of any first-type slot in the first resource pool and a length of any second-type slot in the second resource pool.

In one embodiment, the first equivalent period comprises at least one first-type slot.

In one embodiment, the first equivalent period comprises multiple first-type slots.

In one embodiment, the first equivalent period comprises one first-type slot.

In one embodiment, the first equivalent period comprises multiple first-type multicarrier symbols.

In one embodiment, the first equivalent period comprises at least one first-type slot in the first resource pool.

In one embodiment, the first equivalent period comprises multiple first-type slots in the first resource pool.

In one embodiment, the first equivalent period comprises a first-type slot in the first resource pool.

In one embodiment, the first equivalent period comprises multiple first-type multicarrier symbols in the first resource pool.

In one embodiment, the first equivalent period comprises multiple first-type multicarrier symbols in the first resource pool.

In one embodiment, the first equivalent period is measured by millisecond (ms).

In one embodiment, the first equivalent period is equal to sl-PSFCH-Period.

In one embodiment, for the meaning of sl-PSFCH-Period, refer to section 6.3.5 in 3GPP TS38.331.

In one embodiment, the second resource pool comprises multiple candidate resource sets.

In one embodiment, the multiple candidate resource sets comprised in the second resource pool are TDM.

In one embodiment, the multiple candidate resource sets comprised in the second resource pool are FDM.

In one embodiment, any two of the multiple candidate resource sets comprised in the second resource pool are orthogonal in time domain.

In one embodiment, at least two of the multiple candidate resource sets comprised in the second resource pool are overlapping in frequency domain.

In one embodiment, at least two of the multiple candidate resource sets comprised in the second resource pool are orthogonal in frequency domain.

In one embodiment, any of the multiple candidate resource sets comprised in the second resource pool comprises at least one second-type multicarrier symbol in the second resource pool in time domain.

In one embodiment, any of the multiple candidate resource sets comprised in the second resource pool comprises one second-type multicarrier symbol in the second resource pool in time domain.

In one embodiment, any of the multiple candidate resource sets comprised in the second resource pool comprises two second-type multicarrier symbols in the second resource pool in time domain.

In one embodiment, any of the multiple candidate resource sets comprised in the second resource pool belongs to a second-type slot in the second resource pool in time domain.

In one embodiment, the multiple candidate resource sets comprised in the second resource pool respectively belong to multiple second-type slots in the second resource pool.

In one embodiment, any of the multiple candidate resource sets comprised in the second resource pool comprises at least one second-type PRB in the second resource pool in frequency domain.

In one embodiment, any of the multiple candidate resource sets comprised in the second resource pool comprises a second-type PRB in the second resource pool in frequency domain.

In one embodiment, any of the multiple candidate resource sets comprised in the second resource pool comprises multiple second-type PRBs in the second resource pool in frequency domain.

In one embodiment, any of the multiple candidate resource sets comprised in the second resource pool is used to transmit HARQ information.

In one embodiment, any of the multiple candidate resource sets comprised in the second resource pool is used to transmit HARQ-ACK information.

In one embodiment, any of the multiple candidate resource sets comprised in the second resource pool is used to transmit HARQ-NACK information.

In one embodiment, any of the multiple candidate resource sets comprised in the second resource pool is used to transmit HARQ-ACK or HARQ-NACK information.

In one embodiment, any of the multiple candidate resource sets comprised in the second resource pool comprises at least one PSFCH.

In one embodiment, any of the multiple candidate resource sets comprised in the second resource pool comprises multiple PSFCHs.

In one embodiment, the second period is a time interval.

In one embodiment, the second resource pool comprises multiple candidate resource sets, and the second period is a time interval between any two adjacent candidate resource sets in time domain among the multiple candidate resource sets.

In one embodiment, the second period is a time interval between any two adjacent candidate resource sets in time domain in the multiple candidate resource sets comprised in the second resource pool.

In one embodiment, a first candidate resource set and a second candidate resource set are respectively any two adjacent candidate resource sets in time domain among the multiple candidate resource sets comprised in the second resource pool, and the second period is a time interval between the second candidate resource set and the first candidate resource set.

In one embodiment, a sum of a start of the first candidate resource set in time domain and the second period is a start of the second candidate resource set in time domain.

In one embodiment, the second period comprises at least one second-type slot.

In one embodiment, the second period comprises multiple second-type slots.

In one embodiment, the second period comprises a second-type slot.

In one embodiment, the second period comprises multiple second-type multicarrier symbols.

In one embodiment, the second period comprises at least one second-type slot in the second resource pool.

In one embodiment, the second period comprises multiple second-type slots in the second resource pool.

In one embodiment, the second period comprises a second-type slot in the second resource pool.

In one embodiment, the second period comprises multiple second-type multicarrier symbols in the second resource pool.

In one embodiment, the second period is measured by ms.

In one embodiment, the second period is configured.

In one embodiment, the second period is configured by a higher-layer signaling.

In one embodiment, the second period is configured by an RRC-layer signaling.

In one embodiment, the second period is one or multiple fields in an RRC-layer signaling.

In one embodiment, the second period is configured by sl-PSFCH-Period.

In one embodiment, the first equivalent period is related to the second period.

In one embodiment, the second period is related to the first equivalent period.

In one embodiment, the first equivalent period is related to the at least one second-type slot comprised in the second period.

In one embodiment, the first equivalent period is related to a number of all second-type slots comprised in the second period.

In one embodiment, the first equivalent period is related to a length of any second-type slot comprised in the second period.

In one embodiment, the first equivalent period is related to both a number of all second-type slots comprised in the second period and a length of any second-type slot comprised in the second period.

In one embodiment, the first equivalent period is related to a number of all second-type slots comprised in the second period, a length of any second-type slot comprised in the second period and a length of any first-type slot in the first resource pool.

In one embodiment, a number of all first-type slots comprised in the first equivalent period is related to the second period.

In one embodiment, a number of all first-type slots comprised in the first equivalent period is related to a number of all second-type slots comprised in the second period.

In one embodiment, a number of all first-type slots comprised in the first equivalent period is related to both a number of all second-type slots comprised in the second period and a length of any second-type slot comprised in the second period.

In one embodiment, a number of all first-type slots comprised in the first equivalent period is related to a number of all second-type slots comprised in the second period, a length of any second-type slot comprised in the second period and a length of any first-type slot in the first resource pool.

In one embodiment, the first equivalent period is not less than the second period.

In one embodiment, the first equivalent period is greater than the second period.

In one embodiment, the first equivalent period is equal to the second period.

In one embodiment, the first equivalent period is not greater than the second period.

In one embodiment, the first equivalent period is linearly associated with the second period.

In one embodiment, the first equivalent period is an positive integral multiple of the second period.

In one embodiment, the first equivalent period is a multiple of the second period.

In one embodiment, the second period is a positive integral multiple of the first equivalent period.

In one embodiment, the second period is a multiple of the first equivalent period.

In one embodiment, the first equivalent period is related to a second-type slot in the second resource pool.

In one embodiment, the first equivalent period is related to a length of a first-type slot in the first resource pool.

In one embodiment, the first equivalent period is related to both a second-type slot in the second resource pool and a first-type slot in the first resource pool.

In one embodiment, the first equivalent period is related to both a length of a second-type slot in the second resource pool and a length of a first-type slot in the first resource pool.

In one embodiment, the first equivalent period is related to a number of all second-type slots comprised in the second period and a length of any second-type slot in the second resource pool.

In one embodiment, the second period is used to determine the first equivalent period.

In one embodiment, a number of all second-type slots comprised in the second period is used to determine the first equivalent period.

In one embodiment, a length of any second-type slot comprised in the second period is used to determine the first equivalent period.

In one embodiment, a number of all second-type slots comprised in the second period and a length of any second-type slot comprised in the second period are used to determine the first equivalent period.

In one embodiment, a number of all second-type slots comprised in the second period, a length of any second-type slot comprised in the second period and a length of any first-type slot in the first resource pool are used to determine the first equivalent period.

In one embodiment, a length of a second-type slot in the second resource pool and a length of a first-type slot in the first resource pool are used to determine the first equivalent period.

In one embodiment, a length of a second-type slot in the second resource pool and a number of all second-type slots comprised in the second period are used to determine the first equivalent period.

In one embodiment, a length of any second-type slot in the second resource pool, a number of all second-type slots comprised in the second period and a length of any first-type slot in the first resource pool are used to determine a number of all first-type slots comprised in the first equivalent period.

### Embodiment 7

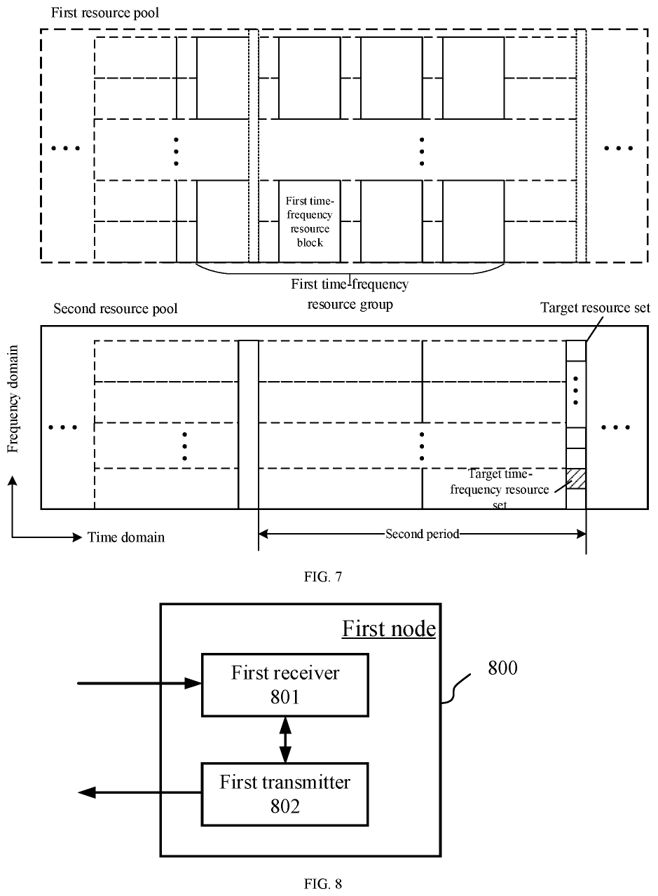

Embodiment 7 illustrates a schematic diagram of relations among a first time-frequency resource block, a target resource set and a target time-frequency resource block according to one embodiment of the present application, as shown in FIG. 7. In FIG. 7, the big dashed rectangle represents a first resource pool in the present application, and the big solid box represents a second resource pool in the present application; the solid rectangle in the first resource pool represents a first-type time-frequency resource block in a first time-frequency resource group in the present application; the solid square in the second resource pool represents a third-type time-frequency resource block in a target resource set in the present application, and the slash-filled rectangle represents a target time-frequency resource block in the present application.

In embodiment 7, the target resource set is one of multiple candidate resource sets comprised in the second resource pool; the target resource set comprises multiple third-type time-frequency resource blocks, and the target time-frequency resource block is one of the multiple third-type time-frequency resource blocks comprised in the target resource set; the first time-frequency resource block is a first-type time-frequency resource block in the first time-frequency resource group, and the first time-frequency resource block is used to determine the target time-frequency resource block.

In one embodiment, the first time-frequency resource block is one of the multiple first-type time-frequency resource blocks comprised in the first resource pool.

In one embodiment, the first time-frequency resource block is one of the multiple first-type time-frequency resource blocks comprised in the first resource group.

In one embodiment, the first time-frequency resource block belongs to a first-type slot in the first resource pool in time domain.

In one embodiment, the first time-frequency resource block comprises at least one first-type multicarrier symbol in the first resource pool in time domain.

In one embodiment, the first time-frequency resource block comprises at least one first-type sub-channel in the first resource pool in frequency domain.

In one embodiment, the first time-frequency resource block comprises at least one first-type PRB in the first resource pool in frequency domain.

In one embodiment, the first time-frequency resource block comprises multiple first-type subcarriers in the first resource pool in frequency domain.

In one embodiment, the first time-frequency resource block comprises a PSCCH.

In one embodiment, the first time-frequency resource block comprises a PSSCH.

In one embodiment, the first time-frequency resource block comprises a PSFCH.

In one embodiment, the first time-frequency resource block comprises a PSCCH and a PSSCH.

In one embodiment, the first time-frequency resource block comprises a PUSCH.

In one embodiment, the first time-frequency resource block comprises a PDSCH.

In one embodiment, the second resource pool comprises the second time-frequency resource group.

In one embodiment, the second time-frequency resource group belongs to the second resource pool.

In one embodiment, the second time-frequency resource group comprises at least one second-type time-frequency resource block.

In one embodiment, the second time-frequency resource group comprises at least one second-type time-frequency resource block in the second resource pool.

In one embodiment, time-domain resources occupied by the second time-frequency resource group in time domain are not greater than the second period.

In one embodiment, time-domain resources occupied by the second time-frequency resource group in time domain are equal to the second period.

In one embodiment, time-domain resources occupied by the second time-frequency resource group in time domain are less than the second period.

In one embodiment, the second time-frequency resource group is related to the second period.

In one embodiment, time-domain resources occupied by the second time-frequency resource group in time domain are related to the second equivalent period.

In one embodiment, a number of the at least one second-type time-frequency resource block comprised in the second time-frequency resource group is related to the second period.

In one embodiment, both a number of the at least one first-type time-frequency resource block comprised in the first time-frequency resource group and a number of the at least one second-type time-frequency resource block comprised in the second time-frequency resource group are related to the second period.

In one embodiment, the second period is used to determine the second time-frequency resource group.

In one embodiment, the second period is used to determine a number of the at least one second-type time-frequency resource block comprised in the second time-frequency resource group.

In one embodiment, the second period is used to determine time-domain resources occupied by the second time-frequency resource group in time domain.

In one embodiment, the second period is used to determine a number of the second-type slot(s) occupied by the second time-frequency resource group in time domain.

In one embodiment, a number of all second-type time-frequency resource blocks in the second time-frequency resource group and a number of the multiple second-type sub-channels comprised in the second resource pool in frequency domain are related to the second period.

In one embodiment, a number of all second-type time-frequency resource blocks in the second time-frequency resource group is related to a product of a number of the multiple second-type sub-channels comprised in the second resource pool in frequency domain and a number of all second-type slots comprised in the second period.

In one embodiment, a number of all second-type time-frequency resource blocks in the second time-frequency resource group is not greater than a product of a number of the multiple second-type sub-channels comprised in the second resource pool in frequency domain and a number of all second-type slots comprised in the second period.

In one embodiment, a number of all second-type time-frequency resource blocks in the second time-frequency resource group is equal to a product of a number of the multiple second-type sub-channels comprised in the second resource pool in frequency domain and a number of all second-type slots comprised in the second period.

In one embodiment, a number of the multiple second-type sub-channels comprised in the second resource pool and the second period are used to determine a number of all second-type time-frequency resource block(s) in the second time-frequency resource group.

In one embodiment, a number of the multiple second-type sub-channels comprised in the second resource pool and a number of all second-type slots comprised in the second period are used to determine a number of all second-type time-frequency resource block(s) in the second time-frequency resource group.

In one embodiment, the target resource set is one of the multiple candidate resource sets comprised in the second resource pool.

In one embodiment, the target resource set comprises at least one second-type multicarrier symbol in the second resource pool in time domain.

In one embodiment, the target resource set belongs to a second-type slot in the second resource pool.

In one embodiment, time-domain resources occupied by the target resource set belong to a second-type slot in the second resource pool.

In one embodiment, the target resource set comprises at least one second-type PRB in the second resource pool in frequency domain.

In one embodiment, the target resource set comprises multiple second-type PRBs in the second resource pool in frequency domain.

In one embodiment, the target resource set comprises at least one PSFCH.

In one embodiment, the target resource set comprises multiple PSFCHs.

In one embodiment, the target resource set comprises at least one third-type time-frequency resource block.

In one embodiment, the target resource set comprises multiple third-type time-frequency resource blocks.

In one embodiment, the multiple third-type time-frequency resource blocks comprised in the target resource set are FDM.

In one embodiment, the multiple third-type time-frequency resource blocks comprised in the target resource set are orthogonal in frequency domain.

In one embodiment, the multiple third-type time-frequency resource blocks comprised in the target resource set are overlapping in time domain.

In one embodiment, any of the multiple third-type time-frequency resource blocks comprised in the target resource set comprises at least one second-type multicarrier symbol in time domain.

In one embodiment, the at least one third-type time-frequency resource block comprised in the target resource set belongs to a second-type slot in the second resource pool in time domain.

In one embodiment, any of the at least one third-type time-frequency resource block comprised in the target resource set comprises at least one second-type PRB in the second resource pool in frequency domain.

In one embodiment, frequency-domain resources occupied by any of the at least one third-type time-frequency resource block comprised in the target resource set in frequency domain are a second-type PRB in the second resource pool in frequency domain.

In one embodiment, frequency-domain resources occupied by any of the at least one third-type time-frequency resource block comprised in the target resource set in frequency domain belong to a second-type sub-channel in the second resource pool in frequency domain.

In one embodiment, frequency-domain resources occupied by any of the at least one third-type time-frequency resource block comprised in the target resource set in frequency domain belong to a second-type sub-channel in the second resource pool in frequency domain.

In one embodiment, frequency-domain resources occupied by the at least one third-type time-frequency resource block comprised in the target resource set in frequency domain belong to at least one second-type sub-channel in the second resource pool in frequency domain.

In one embodiment, any of the at least one third-type time-frequency resource block comprised in the target resource set comprises a PSFCH.

In one embodiment, any of the at least one third-type time-frequency resource block comprised in the target resource set is a PSFCH.

In one embodiment, any of the at least one third-type time-frequency resource block comprised in the target resource set is used to transmit HARQ information.

In one embodiment, any of the at least one third-type time-frequency resource block comprised in the target resource set is used to transmit HARQ-ACK information.

In one embodiment, any of the at least one third-type time-frequency resource block comprised in the target resource set is used to transmit HARQ-NACK information.

In one embodiment, any of the at least one third-type time-frequency resource blocks comprised in the target resource set is used to transmit HARQ-ACK or HARQ-NACK information.

In one embodiment, the first time-frequency resource block is used to determine the target resource set.

In one embodiment, the first time-frequency resource block is used to determine the target resource set from the multiple candidate resource sets.

In one embodiment, the first time-frequency resource group is used to determine the target resource set.

In one embodiment, the first time-frequency resource group is used to determine the target resource set from the multiple candidate resource sets.

In one embodiment, the first time-frequency resource group is associated with the target resource set.

In one embodiment, any first-type time-frequency resource block in the first time-frequency resource group is associated with at least one third-type time-frequency resource block in the target resource set.

In one embodiment, any first-type time-frequency resource block in the first time-frequency resource group is used to determine at least one third-type time-frequency resource block in the target resource set.

In one embodiment, the first time-frequency resource group and the second time-frequency resource group are used to determine the target resource set.

In one embodiment, the first time-frequency resource group and the second time-frequency resource group are used to determine the target resource set from the multiple candidate resource sets.

In one embodiment, the first time-frequency resource group and the second time-frequency resource group are associated with the target resource set.

In one embodiment, any first-type time-frequency resource block in the first time-frequency resource group is associated with at least one third-type time-frequency resource block in the target resource set, and any second-type time-frequency resource block in the second time-frequency resource group is associated with at least one third-type time-frequency resource block in the target resource set.

In one embodiment, any first-type time-frequency resource block in the first time-frequency resource group and any second-type time-frequency resource block in the second time-frequency resource group are respectively used to determine at least two third-type time-frequency resource blocks in the target resource set.

In one embodiment, a first target time-frequency resource block and a second target time-frequency resource block are respectively two third-type time-frequency resource blocks in the target resource set, a first-type time-frequency resource block in the firsts time-frequency resource group is associated with the first target time-frequency resource block, and a second-type time-frequency resource block in the second time-frequency resource group is associated with the second target time-frequency resource block.

In one embodiment, the target resource set comprises a first target resource subset, and the first target resource subset comprises at least one third-type time-frequency resource block.

In one embodiment, the target resource set comprises a second target resource subset, and the second target resource subset comprises at least one third-type time-frequency resource block.

In one embodiment, the target resource set comprises a first target resource subset and a second target resource subset, the first target resource subset comprises at least one third-type time-frequency resource block, and the second target resource subset comprises at least one third-type time-frequency resource block.

In one embodiment, the first target resource subset is different from the second target resource subset.

In one embodiment, the first target resource subset is the same as the second target resource subset.

In one embodiment, the first target resource subset and the second target resource subset are orthogonal.

In one embodiment, the first target resource subset and the second target resource subset are overlapping.

In one embodiment, the first target resource subset and the second target resource subset are FDM.

In one embodiment, both the first target resource subset and the second target resource subset are centrally distributed.

In one embodiment, the first target resource subset and the second target resource subset are cross-discretely distributed.

In one embodiment, any third-type time-frequency resource block in the first target resource subset is different from any third-type time-frequency resource block in the second target resource subset.

In one embodiment, any third-type time-frequency resource block in the second target resource subset is different from any third-type time-frequency resource block in the first target resource subset.

In one embodiment, the first time-frequency resource group is associated with the first target resource subset, and the second time-frequency resource block is associated with the second target resource subset.

In one embodiment, the first time-frequency resource group and the second time-frequency resource block are respectively associated with the first target resource subset and the second target resource subset.

In one embodiment, any first-type time-frequency resource block in the first time-frequency resource group is associated with at least one third-type time-frequency resource block in the first target resource subset, and any second-type time-frequency resource block in the second time-frequency resource group is associated with at least one third-type time-frequency resource block in the second target resource subset.

In one embodiment, “the first time-frequency resource group being associated with the first target resource subset” is equivalent to “the first target subset being associated with the first time-frequency resource group”.

In one embodiment, “the second time-frequency resource group being associated with the second target resource subset” is equivalent to “the second target subset being associated with the second time-frequency resource group”.

In one embodiment, the second target resource subset is used to determine a start of the first target resource subset in frequency domain.

In one embodiment, the second target resource subset is used to determine a start of the second target resource subset in frequency domain.

In one embodiment, a first frequency-domain offset is used to determine frequency-domain resources occupied by the target resource set in the second resource pool.

In one embodiment, a first frequency-domain offset is used to determine a position of the first target resource subset in the target resource set.

In one embodiment, the first frequency-domain offset is configured by a higher-layer signaling.

In one embodiment, the first frequency-domain offset comprises a positive integer number of third-type frequency-domain resource block(s).

In one embodiment, a third-type frequency-domain resource block in the second resource pool comprises at least one PRB.

In one embodiment, all the multiple third-type time-frequency resource blocks comprised in the target resource set belong to a target slot in time domain, and the target slot is a second-type slot in the second resource pool.

In one embodiment, a time interval between a first-type slot occupied by the first time-frequency resource block in the first resource pool and the target slot is not less than a minimum time interval.

In one embodiment, the minimum time interval comprises at least one second-type slot.

In one embodiment, the minimum time interval is equal to a multiple of a reference slot, and the reference slot is one of the first-type slot or the second-type slot.

In one embodiment, the minimum time interval is equal to a reference slot, and the reference slot is one of the first-type slot or the second-type slot.

In one embodiment, the reference slot is the first-type slot.

In one embodiment, the reference slot is the second-type slot.

In one embodiment, the reference slot is a smaller value of the first-type slot or the second-type slot.

In one embodiment, the reference slot is a greater value of the first-type slot or the second-type slot.

In one embodiment, the minimum time interval is a smaller value of a first time interval or a second time interval, the first time interval comprises at least one first-type slot, and the second time interval comprises at least one second-type slot.

In one embodiment, the target time-frequency resource block is one of at least one third-type time-frequency resource block comprised in the target resource set.

In one embodiment, the target time-frequency resource block is one of multiple third-type time-frequency resource blocks comprised in the target resource set.

In one embodiment, the target time-frequency resource block comprises at least one PSFCH.

In one embodiment, the target time-frequency resource block comprises multiple PSFCHs.

In one embodiment, the target time-frequency resource block only has one PSFCH.

In one embodiment, the target time-frequency resource block is time-frequency resources occupied by a PSFCH.

In one embodiment, the target time-frequency resource block is time-frequency resources occupied by multiple PSFCHs, and the multiple PSFCHs are Code Division Multiplexing (CDM).

In one embodiment, the target time-frequency resource block comprises at least one second-type multicarrier symbol in time domain, and the target time-frequency resource block comprises at least one second-type PRB infrequency domain.

In one embodiment, the target time-frequency resource block comprises a second-type multicarrier symbol in time domain, and the target time-frequency resource block comprises a second-type PRB in frequency domain.

In one embodiment, the first time-frequency resource block is associated with the target time-frequency resource block.

In one embodiment, the first time-frequency resource group is associated with the target resource set, and the first time-frequency resource block is associated with the target time-frequency resource block.

In one embodiment, the first time-frequency resource block is used to determine the target time-frequency resource block.

In one embodiment, the first time-frequency resource block is used to determine the target time-frequency resource block from the target resource set.

In one embodiment, the first time-frequency resource group is used to determine the target resource set, and the first time-frequency resource block is used to determine the target time-frequency resource block.

In one embodiment, the first time-frequency resource group is used to determine the target resource set from the multiple candidate resource sets comprised in the second resource pool, and the first time-frequency resource block is used to determine the target time-frequency resource block from the multiple third-type time-frequency resource blocks comprised in the target resource set.

In one embodiment, a position of the first time-frequency resource block in the multiple first-type time-frequency resource blocks comprised in the first time-frequency resource group is used to determine the target time-frequency resource block.

In one embodiment, a position of the first time-frequency resource block in the multiple first-type time-frequency resource blocks comprised in the first time-frequency resource group is used to determine a position of the target time-frequency resource block in the multiple third-type time-frequency resource blocks comprised in the target resource set.

In one embodiment, the target resource set comprises multiple candidate resource groups, and any of the multiple candidate resource groups comprises at least one third-type time-frequency resource block in the target resource set; a target resource group is one of the multiple candidate resource groups, and the target time-frequency resource block belongs to the target resource group; the first time-frequency resource block is used to determine the target resource group.

In one embodiment, the target resource set, a number of the multiple first-type sub-channels comprised in the first resource pool in frequency domain and the first equivalent period are used to determine a number of all third-type time-frequency resource block(s) comprised in the target resource group.

In one embodiment, the first time-frequency resource block is used to determine a position of the target resource group in the multiple candidate resource groups comprised in the target resource group.

In one embodiment, the target resource set is configured by a higher-layer signaling.

In one embodiment, the target resource set occupies multiple third-type frequency resource blocks in frequency domain, and the multiple third-type time-frequency resource blocks comprised in the target resource set respectively occupy the multiple third-type frequency-domain resource blocks in frequency domain.

In one embodiment, the multiple third-type frequency-domain resource blocks occupied by the target resource set in frequency domain are configured by a higher-layer signaling.

### Embodiment 8

Embodiment 8 illustrates a structure block diagram of a processor in first node according to one embodiment of the present application, as shown in FIG. 8. In embodiment 8, a processor 800 in a first node mainly consists of a first receiver 801 and a first transmitter 802.

In one embodiment, the first receiver 801 comprises at least one of the antenna 452, the transmitter/receiver 454, the multi-antenna receiving processor 458, the receiving processor 456, the controller/processor 459, the memory 460 or the data source 467 in FIG. 4 of the present application.

In one embodiment, the first transmitter 802 comprises at least one of the antenna 452, the transmitter/receiver 454, the multi-antenna transmitting processor 457, the transmitting processor 468, the controller/processor 459, the memory 460, or the data source 467 in FIG. 4 of the present application.

In embodiment 8, the first receiver 801 receives a first signal on a first time-frequency resource block; as a response to receiving the first signal, the first transmitter 802 transmits first information on a target time-frequency resource block, and the first information is used to indicate whether the first signal is correctly received; a first resource pool comprises a first time-frequency resource group, the first time-frequency resource group comprises at least one first-type time-frequency resource block, and the first time-frequency resource block is a first-type time-frequency resource block in the first time-frequency resource group; the first resource pool comprises multiple first-type slots in time domain, and time-domain resources occupied by any first-type time-frequency resource block in the first time-frequency resource group in time domain belong to a first-type slot in the first resource pool; time-domain resources occupied by the first time-frequency resource group in time domain are not greater than a first equivalent period, and the first equivalent period comprises at least one first-type slot; a second resource pool comprises multiple candidate resource sets, a second period is a time interval between any two adjacent candidate resource sets in time domain among the multiple candidate resource sets, a target resource set is one of the multiple candidate resource sets, the target resource set comprises multiple third-type time-frequency resource blocks, and the target time-frequency resource block is a third-type time-frequency resource block in the target resource set; the first time-frequency resource block is associated with the target time-frequency resource block; the second resource pool comprises multiple second-type slots in time domain, and time-domain resources occupied by any third-type time-frequency resource block in the target resource set in time domain belong to a second-type slot in the second resource pool; the second period comprises at least one second-type slot, and the first equivalent period is related to the second period.

In one embodiment, the first equivalent period is related to both a length of a first-type slot in the first resource pool and a length of a second-type slot in the second resource pool.

In one embodiment, the first resource pool comprises multiple first-type time-frequency resource blocks, any first-type time-frequency resource block in the first resource pool comprises multiple first-type subcarriers in frequency domain, the second resource pool comprises multiple second-type time-frequency resource blocks, and any second-type time-frequency resource block in the second resource pool comprises multiple second-type subcarriers in frequency domain; the first equivalent period is related to both an SCS of any first-type subcarrier in the first resource pool and an SCS of any second-type subcarrier in the second resource pool.

In one embodiment, the first resource pool comprises multiple first-type subchannels in frequency domain; the first time-frequency resource block occupies at least one of the multiple first-type sub-channels in frequency domain; a number of the multiple first-type sub-channels comprised in the first resource pool in frequency domain and the first equivalent period are used to determine a number of all first-type time-frequency resource block(s) in the first time-frequency resource group.

In one embodiment, the second resource pool comprises a second time-frequency resource group, and the second time-frequency resource group comprises multiple second-type time-frequency resource blocks; any second-type time-frequency resource block in the second time-frequency resource group occupies a second-type slot in the second resource pool in time domain; the target resource set comprises a first target resource subset and a second target resource subset, the first target resource subset is associated with the first time-frequency resource group, and the second target resource subset is associated with the second time-frequency resource group; the second target resource subset is used to determine a starting position of the first target resource subset in frequency domain.

In one embodiment, a first frequency-domain offset is used to determine frequency-domain resources occupied by the target resource set in the second resource pool.

In one embodiment, all the multiple third-type time-frequency resource blocks comprised in the target resource set belong to a target slot in time domain, and the target slot is a second-type slot in the second resource pool; a time interval between a first-type slot occupied by the first time-frequency resource block in the first resource pool and the target slot is not less than a minimum time interval.

In one embodiment, the first node 800 is a UE.

In one embodiment, the first node 800 is a relay node.

In one embodiment, the first node 900 is a base station.

### Embodiment 9

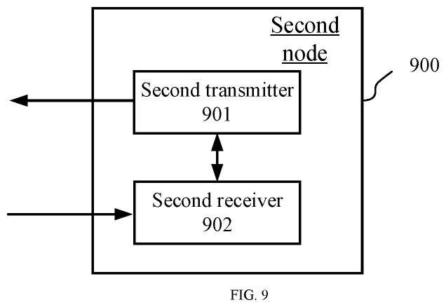

Embodiment 9 illustrates a structure block diagram of a processor in a second node according to one embodiment of the present application, as shown in FIG. 9. In embodiment 9, a processor 900 in a second node mainly consists of a second transmitter 901 and a second receiver 902.

In one embodiment, the second transmitter 901 comprises at least one of the antenna 420, the transmitter/receiver 418, the multi-antenna transmitting processor 471, the transmitting processor 416, the controller/processor 475 or the memory 476 in FIG. 4 of the present application.

In one embodiment, the third receiver 902 comprises at least one of the antenna 420, the transmitter/receiver 418, the multi-antenna receiving processor 472, the receiving processor 470, the controller/processor 475 or the memory 476 in FIG. 4 of the present application.

In embodiment 9, the second transmitter 901 transmits a first signal on a first time-frequency resource block; the second receiver 902 receives first information on a target time-frequency resource block, the first information is used to indicate whether the first signal is correctly received; a first resource pool comprises a first time-frequency resource group, the first time-frequency resource group comprises multiple first-type time-frequency resource blocks, and the first time-frequency resource block is a first-type time-frequency resource block in the first time-frequency resource group; the first resource pool comprises multiple first-type slots in time domain, and any first-type time-frequency resource block in the first time-frequency resource group occupies a first-type slot in the first resource pool in time domain; time-domain resources occupied by the first time-frequency resource group in time domain are not greater than a first equivalent period, and the first equivalent period comprises at least one first-type slot; a second resource pool comprises multiple candidate resource sets, a second period is a time interval between any two adjacent candidate resource sets in time domain among the multiple candidate resource sets, a target resource set is one of the multiple candidate resource sets, the target resource set comprises multiple third-type time-frequency resource blocks, and the target time-frequency resource block is a third-type time-frequency resource block in the target resource set; the first time-frequency resource block is associated with the target time-frequency resource block; the second resource pool comprises multiple second-type slots in time domain, and time-domain resources occupied by any third-type time-frequency resource block in the target resource set in time domain belong to a second-type slot in the second resource pool; the second period comprises at least one second-type slot, and the first equivalent period is related to the second period.

In one embodiment, the first equivalent period is related to both a length of a first-type slot in the first resource pool and a length of a second-type slot in the second resource pool; or, the first resource pool comprises multiple first-type time-frequency resource blocks, any first-type time-frequency resource block in the first resource pool comprises multiple first-type subcarriers in frequency domain, the second resource pool comprises multiple second-type time-frequency resource blocks, and any second-type time-frequency resource block in the second resource pool comprises multiple second-type subcarriers in frequency domain; the first equivalent period is related to both an SCS of any first-type subcarrier in the first resource pool and an SCS of any second-type subcarrier in the second resource pool.

In one embodiment, the first resource pool comprises multiple first-type subchannels in frequency domain; the first time-frequency resource block occupies at least one of the multiple first-type sub-channels in frequency domain; a number of the multiple first-type sub-channels comprised in the first resource pool in frequency domain and the first equivalent period are used to determine a number of all first-type time-frequency resource block(s) in the first time-frequency resource group.

In one embodiment, the second resource pool comprises a second time-frequency resource group, and the second time-frequency resource group comprises multiple second-type time-frequency resource blocks; any second-type time-frequency resource block in the second time-frequency resource group occupies a second-type slot in the second resource pool in time domain; the target resource set comprises a first target resource subset and a second target resource subset, the first target resource subset is associated with the first time-frequency resource group, and the second target resource subset is associated with the second time-frequency resource group; the second target resource subset is used to determine a starting position of the first target resource subset in frequency domain.

In one embodiment, a first frequency-domain offset is used to determine frequency-domain resources occupied by the target resource set in the second resource pool.

In one embodiment, all the multiple third-type time-frequency resource blocks comprised in the target resource set belong to a target slot in time domain, and the target slot is a second-type slot in the second resource pool; a time interval between a first-type slot occupied by the first time-frequency resource block in the first resource pool and the target slot is not less than a minimum time interval.

In one embodiment, the second node 900 is a UE.

In one embodiment, the second node 900 is a relay node.

In one embodiment, the second node 900 is a base station.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The first node in the present application includes but is not limited to mobile phones, tablet computers, notebooks, network cards, low-consumption equipment, enhanced MTC (eMTC) terminals, NB-IOT terminals, vehicle-mounted communication equipment, aircrafts, diminutive airplanes, unmanned aerial vehicles, telecontrolled aircrafts and other wireless communication devices. The second node in the present application includes but is not limited to mobile phones, tablet computers, notebooks, network cards, low-consumption equipment, enhanced MTC (eMTC) terminals, NB-IOT terminals, vehicle-mounted communication equipment, aircrafts, diminutive airplanes, unmanned aerial vehicles, telecontrolled aircrafts and other wireless communication devices. The UE or terminal in the present application includes but is not limited to mobile phones, tablet computers, notebooks, network cards, low-consumption equipment, enhanced MTC (eMTC) terminals, NB-IOT terminals, vehicle-mounted communication equipment, aircrafts, diminutive airplanes, unmanned aerial vehicles, telecontrolled aircrafts, etc. The base station or network side equipment in the present application includes but is not limited to macro-cellular base stations, micro-cellular base stations, home base stations, relay base station, eNB, gNB, Transmitter Receiver Point (TRP), GNSS, relay satellites, satellite base stations, space base stations and other radio communication equipment.

The above are merely the preferred embodiments of the present application and are not intended to limit the scope of protection of the present application. Any modification, equivalent substitute and improvement made within the spirit and principle of the present application are intended to be included within the scope of protection of the present application.

What is claimed is:

1. A first node for wireless communications, comprising:
a first receiver, receiving a first signal on a first time-frequency resource block; and
a first transmitter, as a response to receiving the first signal, transmitting first information on a target time-frequency resource block, the first information being used to indicate whether the first signal is correctly received;
wherein a first resource pool comprises a first time-frequency resource group, the first time-frequency resource group comprises at least one first-type time-frequency resource block, and the first time-frequency resource block is a first-type time-frequency resource block in the first time-frequency resource group; the first resource pool comprises multiple first-type slots in time domain, and time-domain resources occupied by any first-type time-frequency resource block in the first time-frequency resource group in time domain belong to a first-type slot in the first resource pool; time-domain resources occupied by the first time-frequency resource group in time domain are not greater than a first equivalent period, and the first equivalent period comprises at least one first-type slot; a second resource pool comprises multiple candidate resource sets, a second period is a time interval between any two adjacent candidate resource sets in time domain among the multiple candidate resource sets, a target resource set is one of the multiple candidate resource sets, the target resource set comprises multiple third-type time-frequency resource blocks, and the target time-frequency resource block is a third-type time-frequency resource block in the target resource set; the first time-frequency resource block is associated with the target time-frequency resource block; the second resource pool comprises multiple second-type slots in time domain, and time-domain resources occupied by any third-type time-frequency resource block in the target resource set in time domain belong to a second-type slot in the second resource pool; the second period comprises at least one second-type slot, and the first equivalent period is related to the second period.

2. The first node according to claim 1, wherein the first equivalent period is related to both a length of a first-type slot in the first resource pool and a length of a second-type slot in the second resource pool;
or, the first resource pool comprises multiple first-type time-frequency resource blocks, any first-type time-frequency resource block in the first resource pool comprises multiple first-type subcarriers in frequency domain, the second resource pool comprises multiple second-type time-frequency resource blocks, and any second-type time-frequency resource block in the second resource pool comprises multiple second-type subcarriers in frequency domain; the first equivalent period is related to both a Subcarrier Spacing (SCS) of any first-type subcarrier in the first resource pool and an SCS of any second-type subcarrier in the second resource pool.

3. The first node according to claim 1, wherein the first resource pool comprises multiple first-type sub-channels in frequency domain; the first time-frequency resource block occupies at least one of the multiple first-type sub-channels in frequency domain; a number of the multiple first-type sub-channels comprised in the first resource pool in frequency domain and the first equivalent period are used to determine a number of all first-type time-frequency resource block(s) in the first time-frequency resource group.

4. The first node according to claim 1, wherein the second resource pool comprises a second time-frequency resource group, and the second time-frequency resource group comprises multiple second-type time-frequency resource blocks; any second-type time-frequency resource block in the second time-frequency resource group occupies a second-type slot in the second resource pool in time domain; the target resource set comprises a first target resource subset and a second target resource subset, the first target resource subset is associated with the first time-frequency resource group, and the second target resource subset is associated with the second time-frequency resource group; the second target resource subset is used to determine a starting position of the first target resource subset in frequency domain.

5. The first node according to claim 1, wherein a first frequency-domain offset is used to determine frequency-domain resources occupied by the target resource set in the second resource pool.

6. The first node according to claim 1, wherein all the multiple third-type time-frequency resource blocks comprised in the target resource set belong to a target slot in time domain, and the target slot is a second-type slot in the second resource pool; a time interval between a first-type slot occupied by the first time-frequency resource block in the first resource pool and the target slot is not less than a minimum time interval.

7. The first node according to claim 1, wherein the second resource pool and the first resource pool respectively belong to two different Bandwidth Parts (BWPs).

8. A second node for wireless communications, comprising:
a second transmitter, transmitting a first signal on a first time-frequency resource block; and
a second receiver, receiving first information on a target time-frequency resource block, the first information being used to indicate whether the first signal is correctly received;
wherein a first resource pool comprises a first time-frequency resource group, the first time-frequency resource group comprises multiple first-type time-frequency resource blocks, and the first time-frequency resource block is a first-type time-frequency resource block in the first time-frequency resource group; the first resource pool comprises multiple first-type slots in time domain, and any first-type time-frequency resource block in the first time-frequency resource group occupies a first-type slot in the first resource pool in time domain; time-domain resources occupied by the first time-frequency resource group in time domain are not greater than a first equivalent period, and the first equivalent period comprises at least one first-type slot; a second resource pool comprises multiple candidate resource sets, a second period is a time interval between any two adjacent candidate resource sets in time domain among the multiple candidate resource sets, a target resource set is one of the multiple candidate resource sets, the target resource set comprises multiple third-type time-frequency resource blocks, and the target time-frequency resource block is a third-type time-frequency resource block in the target resource set; the first time-frequency resource block is associated with the target time-frequency resource block; the second resource pool comprises multiple second-type slots in time domain, and time-domain resources occupied by any third-type time-frequency resource block in the target resource set in time domain belong to a second-type slot in the second resource pool; the second period comprises at least one second-type slot, and the first equivalent period is related to the second period.

9. The second node according to claim 8, wherein the first equivalent period is related to both a length of a first-type slot in the first resource pool and a length of a second-type slot in the second resource pool; or, the first resource pool comprises multiple first-type time-frequency resource blocks, any first-type time-frequency resource block in the first resource pool comprises multiple first-type subcarriers in frequency domain, the second resource pool comprises multiple second-type time-frequency resource blocks, and any second-type time-frequency resource block in the second resource pool comprises multiple second-type subcarriers in frequency domain; the first equivalent period is related to both an SCS of any first-type subcarrier in the first resource pool and an SCS of any second-type subcarrier in the second resource pool.

10. The second node according to claim 8, wherein the first resource pool comprises multiple first-type sub-channels in frequency domain; the first time-frequency resource block occupies at least one of the multiple first-type sub-channels in frequency domain; a number of the multiple first-type sub-channels comprised in the first resource pool in frequency domain and the first equivalent period are used to determine a number of all first-type time-frequency resource block(s) in the first time-frequency resource group.

11. The second node according to claim 8, wherein the second resource pool comprises a second time-frequency resource group, and the second time-frequency resource group comprises multiple second-type time-frequency resource blocks; any second-type time-frequency resource block in the second time-frequency resource group occupies a second-type slot in the second resource pool in time domain; the target resource set comprises a first target resource subset and a second target resource subset, the first target resource subset is associated with the first time-frequency resource group, and the second target resource subset is associated with the second time-frequency resource group; the second target resource subset is used to determine a starting position of the first target resource subset in frequency domain.

12. The second node according to claim 8, wherein a first frequency-domain offset is used to determine frequency-domain resources occupied by the target resource set in the second resource pool.

13. The second node according to claim 8, wherein all the multiple third-type time-frequency resource blocks comprised in the target resource set belong to a target slot in time domain, and the target slot is a second-type slot in the second resource pool; a time interval between a first-type slot occupied by the first time-frequency resource block in the first resource pool and the target slot is not less than a minimum time interval.

14. The second node according to claim 8, wherein the second resource pool and the first resource pool respectively belong to two different BWPs.

15. A method in a first node for wireless communications, comprising:
receiving a first signal on a first time-frequency resource block; and
as a response to receiving the first signal, transmitting first information on a target time-frequency resource block, the first information being used to indicate whether the first signal is correctly received;
wherein a first resource pool comprises a first time-frequency resource group, the first time-frequency resource group comprises multiple first-type time-frequency resource blocks, and the first time-frequency resource block is a first-type time-frequency resource block in the first time-frequency resource group; the first resource pool comprises multiple first-type slots in time domain, and any first-type time-frequency resource block in the first time-frequency resource group occupies a first-type slot in the first resource pool in time domain; time-domain resources occupied by the first time-frequency resource group in time domain are not greater than a first equivalent period, and the first equivalent period comprises at least one first-type slot; a second resource pool comprises multiple candidate resource sets, a second period is a time interval between any two adjacent candidate resource sets in time domain among the multiple candidate resource sets, a target resource set is one of the multiple candidate resource sets, the target resource set comprises multiple third-type time-frequency resource blocks, and the target time-frequency resource block is a third-type time-frequency resource block in the target resource set; the first time-frequency resource block is associated with the target time-frequency resource block; the second resource pool comprises multiple second-type slots in time domain, and time-domain resources occupied by any third-type time-frequency resource block in the target resource set in time domain belong to a second-type slot in the second resource pool; the second period comprises at least one second-type slot, and the first equivalent period is related to the second period.

16. The method in a first node according to claim 15, wherein the first equivalent period is related to both a length of a first-type slot in the first resource pool and a length of a second-type slot in the second resource pool;
or, the first resource pool comprises multiple first-type time-frequency resource blocks, any first-type time-frequency resource block in the first resource pool comprises multiple first-type subcarriers in frequency domain, the second resource pool comprises multiple second-type time-frequency resource blocks, and any second-type time-frequency resource block in the second resource pool comprises multiple second-type subcarriers in frequency domain; the first equivalent period is related to both an SCS of any first-type subcarrier in the first resource pool and an SCS of any second-type subcarrier in the second resource pool.

17. The method in a first node according to claim 15, wherein the first resource pool comprises multiple first-type sub-channels in frequency domain; the first time-frequency resource block occupies at least one of the multiple first-type sub-channels in frequency domain; a number of the multiple first-type sub-channels comprised in the first resource pool in frequency domain and the first equivalent period are used to determine a number of all first-type time-frequency resource block(s) in the first time-frequency resource group.

18. The method in a first node according to claim 15, wherein the second resource pool comprises a second time-frequency resource group, and the second time-frequency resource group comprises multiple second-type time-frequency resource blocks; any second-type time-frequency resource block in the second time-frequency resource group occupies a second-type slot in the second resource pool in time domain; the target resource set comprises a first target resource subset and a second target resource subset, the first target resource subset is associated with the first time-frequency resource group, and the second target resource subset is associated with the second time-frequency resource group; the second target resource subset is used to determine a starting position of the first target resource subset in frequency domain.

19. The method in a first node according to claim 15, wherein a first frequency-domain offset is used to determine frequency-domain resources occupied by the target resource set in the second resource pool.

20. The method in a first node according to claim 15, wherein all the multiple third-type time-frequency resource blocks comprised in the target resource set belong to a target slot in time domain, and the target slot is a second-type slot in the second resource pool; a time interval between a first-type slot occupied by the first time-frequency resource block in the first resource pool and the target slot is not less than a minimum time interval.
